(19) United States
(12) Patent Application Publication
(10) Pub. No.: US 2015/0236944 A1
(43) Pub. Date: Aug. 20, 2015

(54) RELAY APPARATUS AND INFORMATION PROCESSING APPARATUS

(71) Applicant: FUJITSU LIMITED, Kawasaki-shi (JP)

(72) Inventors: Shinya KANO, Inagi (JP); Kenji Hikichi, Kawasaki (JP)

(21) Appl. No.: 14/701,607

(22) Filed: May 1, 2015

Related U.S. Application Data
(63) Continuation of application No. PCT/JP2012/081491, filed on Dec. 5, 2012.

(51) Int. Cl. H04L 12/715; H04L 12/733; H04L 29/12

(52) U.S. Cl. CPC H04L 45/04; H04L 61/106; H04L 45/20

(57) ABSTRACT

A communicating unit communicates with a plurality of first relay apparatuses belonging to a first network and being options of a transfer destination of data addressed to a second network connected to the first network. A control unit acquires, from each of the first relay apparatuses, distance information indicating distance between the first relay apparatus and a second relay apparatus connected to the first and the second network. Subsequently, the control unit selects the transfer destination of the data amongst the first relay apparatuses based on the distance information.

### CROSS-REFERENCE TO RELATED APPLICATION

This application is a continuation application of International Application PCT/JP2012/081491 filed on Dec. 5, 2012 which designated the U.S., the entire contents of which are incorporated herein by reference.

### FIELD

The embodiments discussed herein are related to a replay apparatus and an information processing apparatus.

### BACKGROUND

Information processing systems including a plurality of information processing apparatuses have currently been in use. The plurality of information processing apparatuses are connected to each other via networks each including one or more relay apparatuses. For example, even if a source information processing apparatus is not directly connected to a destination information processing apparatus, one or more relay apparatuses intervening between the source and destination information processing apparatuses transfer data transmitted by the source information processing apparatus to the destination information processing apparatus.

For example, there are relay apparatuses for relaying by use of a network layer protocol of the Open System Interconnection (OSI) model. Examples of such relay apparatuses are routers and Layer 3 (L3) switches. Some relay apparatuses support dynamic routing. In the dynamic routing, a relay apparatus collects information indicating a connection relation with a different relay apparatus using a predetermined routing protocol. The information indicating a connection relation is sometimes referred to as the “routing information”. Based on the routing information, the relay apparatus evaluates an index for selecting a route (for example, an index of the distance to the different relay apparatus). Based on the index, the relay apparatus selects a route according to a destination and then registers the result in a routing table. Then, the relay apparatus transfers packets based on the routing table.

In recent years, the Internet Engineering Task Force (IETF) has discussed a routing method called the Locator/ID Separation Protocol (LISP). The LISP enables separate management of addresses belonging to a core network and addresses belonging to access networks connected to the core network. A relay apparatus for acquiring packets from an interface on a first access network side and transferring the packets to the core network side is sometimes called Ingress Tunnel Router (ITR). On the other hand, a relay apparatus for acquiring packets from an interface on the core network side and transferring the packets to a second access network side is sometimes called Egress Tunnel Router (ETR). An address of the ETR belonging to the core network is sometimes called Routing Locator (RLOC), and an address of each host in an access network is sometimes called Endpoint Identifier (EID). The mappings between EIDs and RLOCs may be managed by a management apparatus.

When transferring a packet addressed to an EID belonging to the second access network, the ITR is able to resolve a RLOC of a corresponding ETR by querying the management apparatus for the EID. The ITR encapsulates the packet and transfers the packet addressed to the RLOC through the core network. The ETR decapsulates the packet and transfers the packet to the second access network. In this regard, each relay apparatus on the core network intervening between the ITR and the ETR only needs to have a routing table of the core network and need not have routing tables of the first and second access networks. In other words, the relay apparatuses only need to collect routing information of the core network and need not collect routing information of the first and second access networks. Therefore, it is possible to reduce the workload of the relay apparatuses on the core network to select a route.

D. Farinacci et al. “Locator/ID Separation Protocol (LISP) draft-ietf-lisp-22” [online], 12 Feb. 2012, The Internet Engineering Task Force (IETF). Available from: tools.ietf.org/html/draft-ietf-lisp-22. [Accessed: 21 Aug. 2012].

D. Farinacci et al. “Locator/ID Separation Protocol (LISP) draft-ietf-lisp-23” [online], 4 May 2012, The Internet Engineering Task Force (IETF). Available from: tools.ietf.org/html/draft-ietf-lisp-23. [Accessed: 13 Nov. 2012].

It is sometimes the case that a relay apparatus functioning as an ITR is connected to its core network through a plurality of routes, which is called multi-homing. In a multi-homed environment, it may be considered to cause the ITR to collect routing information of the core network and select a route. However, in this case, the ITR has to collect routing information of not only the core network but also its access network and carry out processing to select routes for both the networks. Therefore, the ITR may be put under increased workload.

### SUMMARY

According to an aspect, there is provided an information processing apparatus including: a communication interface configured to receive, when a first relay apparatus connected to a first and a second network selects a transfer destination of data addressed to a third network connected to the second network, a query to resolve an address of a second relay apparatus on the second network from the first relay apparatus, the second relay apparatus being connected to the second and the third network; and a processor configured to perform a procedure including: causing, in response to the query, each of a plurality of third relay apparatuses belonging to the second network and being options of the transfer destination of the data to be transmitted from the first relay apparatus to provide, to the first relay apparatus, distance information indicating distance between the third relay apparatus and the second relay apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing system according to a first embodiment;

FIG. 2 illustrates an information processing system according to a second embodiment;

FIG. 3 illustrates an example of hardware of a router according to the second embodiment;

FIG. 4 illustrates an example of hardware of a server according to the second embodiment;

FIG. 5 illustrates an example of software according to the second embodiment;

FIG. 6 illustrates the example of software according to the second embodiment, continuing from FIG. 5;

FIG. 7 illustrates an example of a neighboring gateway management table according to the second embodiment;

FIG. 8 illustrates an example of a routing table according to the second embodiment;

FIG. 9 illustrates an example of an EID-to-RLOC cache table according to the second embodiment;

FIG. 10 illustrates an example of an EID-to-RLOC management table according to the second embodiment;

FIG. 11 illustrates an example of packets according to the second embodiment;

FIG. 12 illustrates an example of an EID-to-RLOC requesting message according to the second embodiment;

FIG. 13 illustrates an example of EID-to-RLOC reply instruction messages according to the second embodiment;

FIG. 14 illustrates an example of EID-to-RLOC reply messages according to the second embodiment;

FIG. 15 is a flowchart illustrating an example of processing carried out by an ITR according to the second embodiment;

FIG. 16 is a flowchart illustrating an example of processing carried out by a server according to the second embodiment;

FIG. 17 is a flowchart illustrating an example of processing carried out by a network core router according to the second embodiment;

FIG. 18 is a sequence diagram illustrating a processing example according to the second embodiment;

FIG. 19 illustrates an example of software of an ETR according to a third embodiment;

FIG. 20 illustrates an example of a neighboring gateway management table according to the third embodiment;

FIG. 21 illustrates an example of an EID-to-RLOC requesting message according to the third embodiment;

FIG. 22 illustrates an example of an EID-to-RLOC reply instruction message according to the third embodiment;

FIG. 23 illustrates an example of EID-to-RLOC reply messages according to the third embodiment;

FIG. 24 is a flowchart illustrating an example of processing carried out by an ITR according to the third embodiment;

FIG. 25 is a flowchart illustrating an example of processing carried out by a server according to the third embodiment;

FIG. 26 is a flowchart illustrating an example of processing carried out by an ETR according to the third embodiment;

FIG. 27 is a sequence diagram illustrating a processing example according to the third embodiment;

FIG. 28 illustrates an example of EID-to-RLOC requesting messages according to a fourth embodiment;

FIG. 29 illustrates an example of EID-to-RLOC reply instruction messages according to the fourth embodiment;

FIG. 30 is a sequence diagram illustrating a processing example according to the fourth embodiment;

FIG. 31 illustrates an example of an EID-to-RLOC requesting message according to a fifth embodiment;

FIG. 32 illustrates an example of an EID-to-RLOC reply instruction message according to the fifth embodiment;

FIG. 33 illustrates an example of an EID-to-RLOC reply message according to the fifth embodiment;

FIG. 34 is a flowchart illustrating an example of processing carried out by an ITR according to the fifth embodiment;

FIG. 35 is a flowchart illustrating an example of processing carried out by a server according to the fifth embodiment;

FIG. 36 is a flowchart illustrating an example of processing carried out by an ETR according to the fifth embodiment;

FIG. 37 is a sequence diagram illustrating a processing example according to the fifth embodiment;

FIG. 38 illustrates an information processing system according to a sixth embodiment; and

FIG. 39 is a sequence diagram illustrating a processing example according to the sixth embodiment.

### DESCRIPTION OF EMBODIMENTS

Several embodiments will be described below with reference to the accompanying drawings, wherein like reference numerals refer to like elements throughout.

### (a) First Embodiment

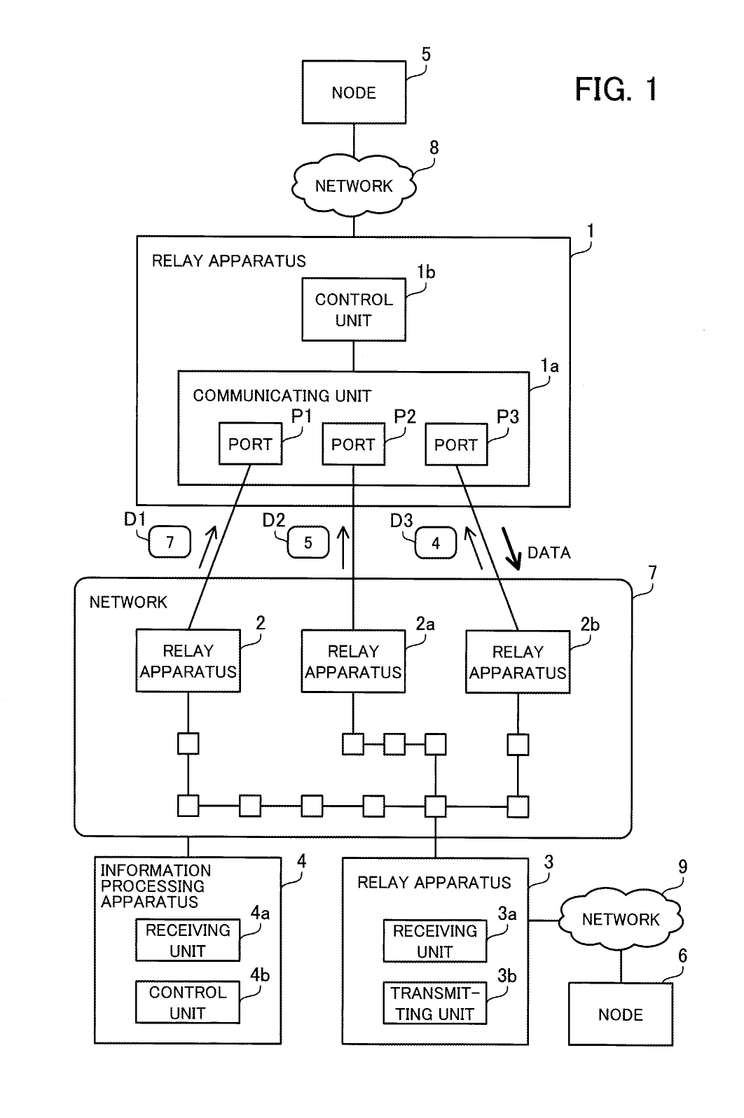

FIG. 1 illustrates an information processing system according to a first embodiment. The information processing system according to the first embodiment includes relay apparatuses 1, 2, 2a, 2b, and 3, an information processing apparatus 4, and nodes 5 and 6. Each of the relay apparatuses 1, 2, 2a, 2b, and 3 is used for data relay. The relay apparatuses 1, 2, 2a, 2b, and 3 may be so-called routers or L3 switches.

The relay apparatus 1 is connected to networks 7 and 8. More specifically, the relay apparatus 1 may be said to be disposed at the border between the networks 7 and 8. The networks 7 and 8 are connected to each other via the relay apparatus 1. The relay apparatuses 2, 2a, and 2b belong to the network 7. The relay apparatuses 2, 2a, and 2b are transfer options for transferring data from the relay apparatus 1 to the network 7. The relay apparatus 3 is connected to the network 7 and a network 9. More specifically, the relay apparatus 3 may be said to be disposed at the border between the networks 7 and 9. The networks 7 and 9 are connected to each other via the relay apparatus 3. The information processing apparatus 4 is connected to the network 7. The node 5 is connected to the network 8 while the node 6 is connected to the network 9.

The network 7 may include a plurality of autonomous systems (ASs). Each autonomous system may be an Internet service provider (ISP) or an internal network (for example, a scholarly network) using an independent operation policy. The networks 8 and 9 may be autonomous systems on the network 7. Each of the relay apparatuses 2, 2a, and 2b may belong to a different autonomous system. The networks 7, 8, and 9 may be Internet Protocol (IP) networks. Data relayed by the relay apparatuses 1, 2, 2a, 2b, and 3 may be so-called IP packets or packets.

The relay apparatus 1 includes a communicating unit 1a and a control unit 1b. The communicating unit 1a communicates with the relay apparatuses 2, 2a, and 2b. The communicating unit 1a includes ports P1, P2, and P3. The port P1 is an interface connected to the relay apparatus 2. Similarly, the ports P2 and P3 are interfaces connected to the relay apparatuses 2a and 2b, respectively.

In selecting a transfer destination of data addressed to the network 9, the control unit 1b acquires, from the replay apparatuses 2, 2a, and 2b, information D1, D2, and D3, respectively, each indicating the distance between the corresponding relay apparatus 2/2a/2b and the relay apparatus 3. Based on the distance information D1, D2, and D3, the control unit 1b selects the data transfer destination amongst the relay apparatuses 2, 2a, and 2b. For example, each of the distance information D1, D2, and D3 may indicate the hop count from the corresponding relay apparatus 2/2a/2b to the relay apparatus 3. The hop count may be an index indicating the number of relay apparatuses intervening between each relay apparatus 2/2a/2b and the relay apparatus 3. Alternatively, the hop count may be an index indicating the number of autonomous systems intervening between each relay apparatus 2/2a/2b and the relay apparatus 3. Either one of these is sufficient to be used as an index indicating the distance.

As each of the distance information D1, D2, and D3, the control unit 1b may acquire information indicating the shortest distance from the corresponding relay apparatus 2/2a/2b. For example, in the case where a plurality of routes are available between the relay apparatuses 2 and 3, the control unit 1b may acquire, amongst the routes, only one route with the smallest count of hops from the relay apparatus 2. Alternatively, each of the distance information D1, D2 and D3 may be a value obtained by multiplying the hop count by a predetermined value (for example, 1).

Further, information indicating limitation of the hop count allowed (the upper limit of the number of transfers) in each route may be used as the distance information D1, D2, and D3. The information corresponds to a time to live (TTL) or hop limit for the Internet Protocol. A TTL value or a hop limit value is subtracted by 1 for each pass through a relay apparatus. Therefore, the TTL or the hop limit is also used as an index indicating the distance. Specifically, the relay apparatus 1 is able to evaluate individual distances to the relay apparatus 3 based on the TTL or hop limit values included in IP packets each having been transmitted from the relay apparatus 3 and then having reached the relay apparatus 1 via a different one of the relay apparatuses 2, 2a, and 2b. If the routes between the relay apparatus 1 and each of the relay apparatuses 2, 2a, and 2b have the same hop count, for example, “1”, the TTL or hop limit may be used as the index indicating the distance between each of the relay apparatuses 2, 2a, and 2b and the relay apparatus 3.

Now here assume a case of transferring data from the node 5 to the node 6. The node 6 belongs to the network 9. Therefore, the data addressed to the node 6 is addressed also to the network 9. The control unit 1b acquires the distance information D1, D2, and D3 each indicating the distance from the corresponding relay apparatus 2/2a/2b to the relay apparatus 3. For example, the distance information D1 acquired from the relay apparatus 2 has an index of 7; the distance information D2 acquired from the relay apparatus 2a has an index of 5; and the distance information D3 acquired from the relay apparatus 2b has an index of 4. Assume here that the distance is less with a smaller value of the index. In this case, the control unit 1b selects, for example, the relay apparatus 2b with the shortest distance as the transfer destination. In this regard, the relay apparatus 1 sends out the data to be transferred from the port P3 connected to the relay apparatus 2b.

As described above, when selecting a transfer destination of the data addressed to the network 9, the control unit 1b acquires the distance information D1, D2 and D3 from the relay apparatuses 2, 2a, and 2b, respectively. Such control is implemented, for example, in the following manner. Note here that the relay apparatus 3 includes a receiving unit 3a and a transmitting unit 3b, and the information processing apparatus 4 includes a receiving unit 4a and a control unit 4b.

The information processing apparatus 4 may manage a mapping between an address of the relay apparatus 3 on the network 7 and an address of the node 6 on the network 9. This is, for example, the case of using the LISP for routing in the network 7. When transferring data addressed to the node 6, the relay apparatus 1 queries the information processing apparatus 4 for the address of the node 6 to thereby resolve the address of the relay apparatus 3 on the network 7. In this regard, the receiving unit 4a of the information processing apparatus 4 receives the query. The control unit 4b causes the relay apparatuses 2, 2a, and 2b to provide the distance information D1, D2, and D3, respectively, to the relay apparatus 1. Specifically, a receiving unit (not illustrated) of each of the relay apparatuses 2, 2a, and 2b receives, from the control unit 4b, an instruction to provide the corresponding distance information D1/D2/D3. In response to the instruction, a transmitting unit (not illustrated) of each of the relay apparatuses 2, 2a, and 2b transmits the corresponding distance information D1/D2/D3 to the relay apparatus 1. Thus, the control unit 4b may directly instruct the relay apparatuses 2, 2a, and 2b to provide the distance information D1, D2, and D3.

Alternatively, the control unit 4b may cause the relay apparatus 3 to transmit a plurality of IP packets each to reach the relay apparatus 1 through a different one of the relay apparatuses 2, 2a, and 2b. In this regard, the receiving unit 3a of the relay apparatus 3 receives a transmission instruction from the control unit 4b. According to the transmission instruction, the transmitting unit 3b transmits the plurality of IP packets. Each of the IP packets includes a TTL or hop limit. Thus, the control unit 4b may cause the relay apparatuses 2, 2a, and 2b to indirectly provide the distance information D1, D2, and D3.

As described above, in selecting a transfer destination of the data addressed to the network 9, the control unit 1b is able to acquire the distance information D1, D2, and D3 from the relay apparatuses 2, 2a, and 2b, for example, by making a query to resolve the address of the relay apparatus 3. In this case, it is possible to select the transfer destination upon a response to the query, thus enabling efficient processing.

According to the relay apparatus 1, in selecting a transfer destination of the data addressed to the network 9, the control unit 1b acquires, from the replay apparatuses 2, 2a, and 2b being transfer destination options, the distance information D1, D2, and D3, respectively, each indicating the distance between the corresponding relay apparatus 2/2a/2b and the relay apparatus 3. Based on the distance information D1, D2, and D3, the control unit 1b selects a data transfer destination amongst the relay apparatuses 2, 2a, and 2b.

Herewith, the relay apparatus 1 is able to select a route without routing information of the network 7. For example, in the case of being connected to the network 7 in a multi-homed architecture, the relay apparatus 1 needs to select a data transfer destination on the network 7 amongst a plurality of options. In this case, it may be considered to cause the relay apparatus 1 to collect the routing information of the network 7 in order to select a route. However, the relay apparatus 1 is connected also to the network 8. Therefore, for the network 8 besides the network 7, the relay apparatus 1 needs to collect routing information and carry out the route selecting process.

In this case, the relay apparatus 1 may be put under increased workload. For example, the relay apparatus 1 may need a relatively large area of memory in order to hold the routing information of both the networks 7 and 8. In addition, since the route selecting process needs to be carried out for each of the networks 7 and 8, processing costs involved in evaluating route selection indexes may increase. Further, when the network 7 is large-scale like a core network, the load on the relay apparatus 1 may especially increase. This is because the amount of routing information needed to be collected and the amount of routing information to be processed increase as there are a larger number of networks residing inside.

In view of this, in transferring the data addressed to the network 9, the relay apparatus 1 acquires, from the relay apparatuses 2, 2a, and 2b, the distance information D1, D2, and D3, respectively, each indicating the distance to the relay apparatus 3 connected to the network 9. Then, based on the distance information D1, D2, and D3, the relay apparatus 1 selects the data transfer destination. That is, acquiring such indexes representing the distances between the individual relay apparatuses 2, 2a, and 2b and the relay apparatus 3 allows for an evaluation of differences in the distances from the relay apparatus 1 to the relay apparatus 3 via the individual relay apparatuses 2, 2a, and 2b.

For example, when the hop count from the relay apparatus 1 to each of the relay apparatuses 2, 2a, and 2b is a predetermined value (for example, 1), differences in the distances from the relay apparatus 1 to the relay apparatus 3 via each of the relay apparatuses 2, 2a, and 2b are equal to those in the distances from each of the relay apparatuses 2, 2a, and 2b to the relay apparatus 3. More specifically, when the distance between the relay apparatuses 2 and 3 has an index of 7 and the distance between the relay apparatuses 2a and 3 has an index of 5, the difference in the distances is 2, which allows for an evaluation that the distance between the relay apparatuses 2a and 3 is less by the difference. The difference does not change when the predetermined value is added to both the indexes. Therefore, based on the distance information D1, D2, and D3, the relay apparatus 1 is able to select, for example, the relay apparatus 2b having the shortest distance to the relay apparatus 3 as the transfer destination. The shortest route is selected here to ensure efficient data transfer.

As described above, the relay apparatus 1 selects the transfer destination based on the distance information D1, D2, and D3 acquired from the relay apparatuses 2, 2a, and 2b, respectively. This eliminates the need for the relay apparatus 1 to collect routing information of the network 7. In addition, the relay apparatus 1 need not calculate indexes for evaluating routes on the network 7 by itself. That is, the relay apparatus 1 is able to select a route without the routing information. As a result, the workload on the relay apparatus 1 is reduced. For example, the relay apparatus 1 does not have to allocate a memory area for the routing control, therefore saving the memory area. In addition, for example, processing costs involved in route selection by the relay apparatus 1 are reduced.

### (b) Second Embodiment

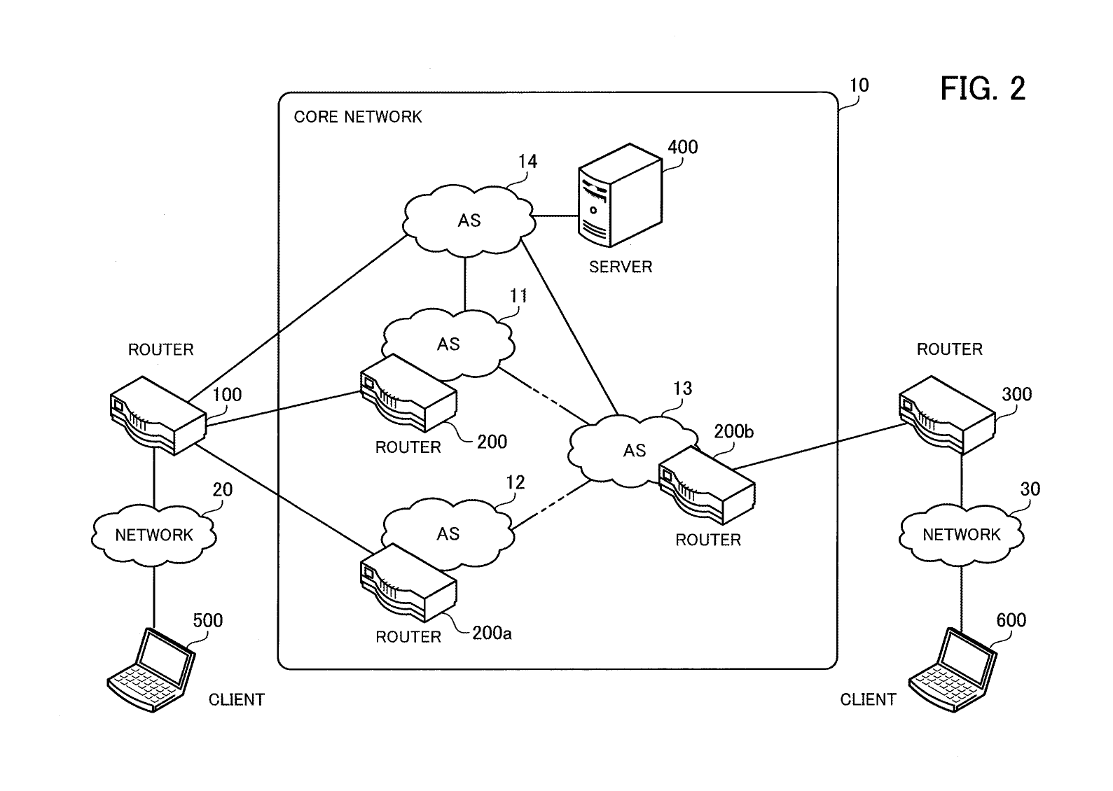

FIG. 2 illustrates an information processing system according to a second embodiment. The information processing system of the second embodiment includes routers 100, 200, 200a, 200b, and 300, a server 400, and clients 500 and 600. The routers 100, 200, 200a, 200b, and 300 and the server 400 are connected to a core network 10.

The core network 10 is a major network in a wide area network, such as the Internet and a wide area network (WAN). The core network 10 includes autonomous systems (ASs) 11, 12, 13, and 14. For example, each of the autonomous systems 11, 12, 13, and 14 is an ISP or an internal network. The autonomous systems 11, 13, and 14 are connected to one another. The autonomous systems 12 and 13 are connected to each other. Between two autonomous systems, one or more different autonomous systems may intervene. The core network 10 is sometimes referred to as the “network core”.

The router 100 and the client 500 are connected to the network 200. The router 100 is connected to the routers 200 and 200a and the autonomous system 14. The router 200 is connected to the autonomous system 11. The router 200a is connected to the autonomous system 12. The router 200b is connected to the router 300 and the autonomous system 13. The server 400 is connected to the autonomous system 14. The router 300 and the client 600 are connected to the network 30.

The core network 10, the autonomous systems 11, 12, 13, and 14, and the networks 20 and 30 are IP networks. The routers 100, 200, 200a, 200b, and 300 are relay apparatuses for routing IP packets (hereinafter simply referred to as “packets”) in the network layer (Layer 3) of the OSI model. The LISP is used for routing in the core network 10. The autonomous system 14 is a LISP management network and is therefore not involved in normal packet transfer.

The router 100 relays communication between the core network 10 and the network 20. The router 300 relays communication between the core network 10 and the network 30. The routers 100 and 300 may also be referred to as “customer edge (CE)” routers of the networks 20 and 30, respectively. The routers 100 and 300 function as an ITR and an ETR, respectively, in the core network 10. For this reason, each of the routers 100 and 300 is also referred to as the “xTR”.

Now here assume a case of transmitting a packet from the client 500 to the client 600. In this case, the router 100 encapsulates the packet and then transfers the encapsulated packet to the core network 10. That is, the router 100 functions as an ITR. The ITR may also be referred to as the “ingress edge node” of the core network 10. On the other hand, the router 300 transfers a decapsulated packet to the network 30. That is, the router 300 functions as an ETR. The ETR may also be referred to as the “egress edge node” of the core network 10. In the following description, a packet being encapsulated is sometimes referred to simply as the “encapsulated packet”.

The router 100 is connected to the routers 200 and 200a, as described above. That is, the router 100 is multi-homed. Connecting a multi-homing router to the core network 10 is sometimes called “multi-homing”.

The router 200 transfers a packet or an encapsulated packet received from the router 100 into the autonomous system 11. In addition, the router 200 transfers a packet or an encapsulated packet received at its interface on the autonomous system 11 side to the router 100. The router 200a transfers a packet or an encapsulated packet received from the router 100 into the autonomous system 12. In addition, the router 200a transfers a packet or an encapsulated packet received at its interface on the autonomous system 12 side to the router 100. The router 200b transfers a packet or an encapsulated packet received at its interface on the autonomous system 13 side to the router 300. In addition, the router 200b transfers a packet or an encapsulated packet received from the router 300 into the autonomous system 13.

The server 400 is a server computer for managing mappings between EIDs and RLOCs. In response to a query from the ITR to resolve an EID-to-RLOC mapping, the server 400 provides the ITR with a RLOC corresponding to a queried EID.

The clients 500 and 600 are client computers used by users. The clients 500 and 600 are individually assigned unique EIDs. For example, the client 500 transmits a packet with the EID of the client 600 being designated as its destination. The packet is routed through the network 20, the core network 10, and the network 30 to then reach the client 600.

Note that a routing protocol for exchanging routing information between two autonomous systems (Exterior Gateway Protocol (EGP)) in the core network 10 is, for example, Boarder Gateway Protocol (BGP). Note however that the routers 100 and 300 may not participate in EGP if they have a function described later. Routing protocols used within the autonomous systems and the networks 20 and 30 (Interior Gateway Protocols (IGPs)) are, for example, Open Shortest Path First (OSPF) and Routing Information Protocol (RIP).

Addresses used in the second embodiment is IP addresses. The IP addresses may be Internet Protocol version 4 (IPv4) addresses or Internet Protocol version 6 (IPv6) addresses. IP addresses of the routers 100, 200, 200a, 200b, and 300 belong to individual network addresses used for routing in the core network 10. For this reason, the routers 100, 200, 200a, 200b, and 300 would be said to belong to the core network 10. Further, the core network 10 may be considered to be formed by connecting the routers 100, 200, 200a, 200b, and 300 using predetermined lines. Since having a network 20-side IP address, the router 100 also belongs to the network 20. In a similar fashion, the router 300 also belongs to the network 30 since having a network 30-side IP address. The routers 100, 200, 200a, 200b, and 300 may be so-called L3 switches.

The information processing system of the second embodiment is an example of the information processing system of the first embodiment. For example, the router 100 is an example of the relay apparatus 1; the routers 200 and 200a are examples of the relay apparatuses 2a, 2b, and 2c; the router 300 is an example of the relay apparatus 3; and the server 400 is an example of the information processing apparatus 4.

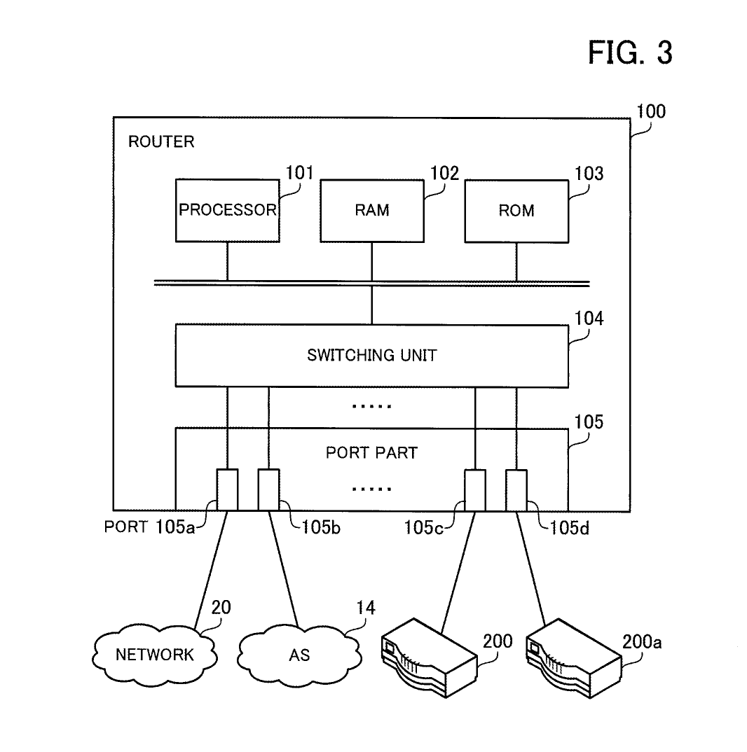

FIG. 3 illustrates an example of hardware of a router according to the second embodiment. The router 100 includes a processor 101, random access memory (RAM) 102, read only memory (ROM) 103, a switching unit 104, and a port part 105. The routers 200, 200a, 200b, and 300 may individually be implemented using the same hardware components as the router 100.

The processor 101 controls information processing of the router 100. The processor 101 may be a multi-processor. The processor 101 is, for example, a central processing unit (CPU), a micro processing unit (MPU), a digital signal processor (DSP), an application specific integrated circuit (ASIC), a field programmable gate array (FPGA), a programmable logic device (PLD), or a combination of two or more of these. The RAM 102 temporarily stores therein firmware programs and data. The programs and data stored in the RAM 102 are used by the processor 101 for its processing. The ROM 103 preliminarily stores therein firmware programs and data. The ROM 103 may be rewritable nonvolatile memory, such as flash memory. The programs and data stored in the ROM 103 are used by the processor 101 for its processing.

The switching unit 104 sends out a packet received by a port of the port part 105 to a different port. The port part 105 includes a plurality of ports. The plurality of ports include ports 105a, 105b, 105c, and 105d. The port 105a is connected to the network 20. The port 105b is connected to the autonomous system 14. The port 105c is connected to the router 200. The port 105d is connected to the router 200a.

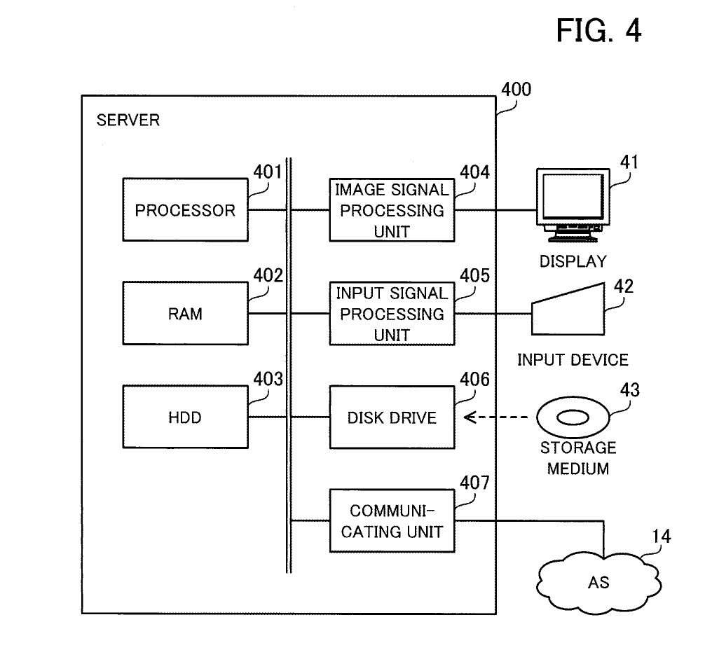

FIG. 4 illustrates an example of hardware of a server according to the second embodiment. The server 400 includes a processor 401, RAM 402, a hard disk drive (HDD) 403, an image signal processing unit 404, an input signal processing unit 405, a disk drive 406, and a communicating unit 407. The clients 500 and 600 may individually be implemented using the same hardware components as the server 400.

The processor 401 controls information processing of the server 400. The processor 401 may be a multi-processor. The processor 401 is, for example, a CPU, a MPU, a DSP, an ASIC, a FPGA, a PLD, or a combination of two or more of these. The RAM 402 is used as a main storage device of the server 400. The RAM 402 temporarily stores at least part of an operating system (OS) program and application programs to be executed by the processor 401. The RAM 402 also stores therein various types of data to be used by the processor 401 for its processing.

The HDD 403 is a secondary storage device of the server 400, and magnetically writes and reads data to and from a built-in magnetic disk. The HDD 403 stores therein the OS program, application programs, and various types of data. Instead of the HDD 403, the server 400 may be provided with a different type of secondary storage device such as flash memory or a solid state drive (SSD), or may be provided with a plurality of secondary storage devices.

The image signal processing unit 404 outputs an image to a display 41 connected to the server 400 according to an instruction from the processor 401. A cathode ray tube (CRT) display or a liquid crystal display, for example, may be used as the display 41. The input signal processing unit 405 acquires an input signal from an input device 42 connected to the server 400, and outputs the signal to the processor 401. A pointing device, such as a mouse and a touch panel, or a keyboard may be used as the input device 42.

The disk drive 406 is a drive unit for reading programs and data recorded on a storage medium 43 using, for example, laser light. Examples of the storage medium 43 include a digital versatile disc (DVD), DVD-RAM, a compact disk read only memory (CD-ROM), a CD recordable (CD-R), and a CD-rewritable (CD-RW). The storage medium 43 may be a storage device with built-in semiconductor memory or a built-in magnetic disk. According to an instruction from the processor 401, for example, the disk drive 406 stores programs and data read from the storage medium 43 in the RAM 402 or the HDD 403.

The communicating unit 407 is an interface for communicating with other computers and routers via the autonomous system 14. The communicating unit 407 may be a wired or wireless interface. After the communicating unit 407 receives programs and data from other computers, the processor 401 stores them, for example, in the RAM 402 and the HDD 403.

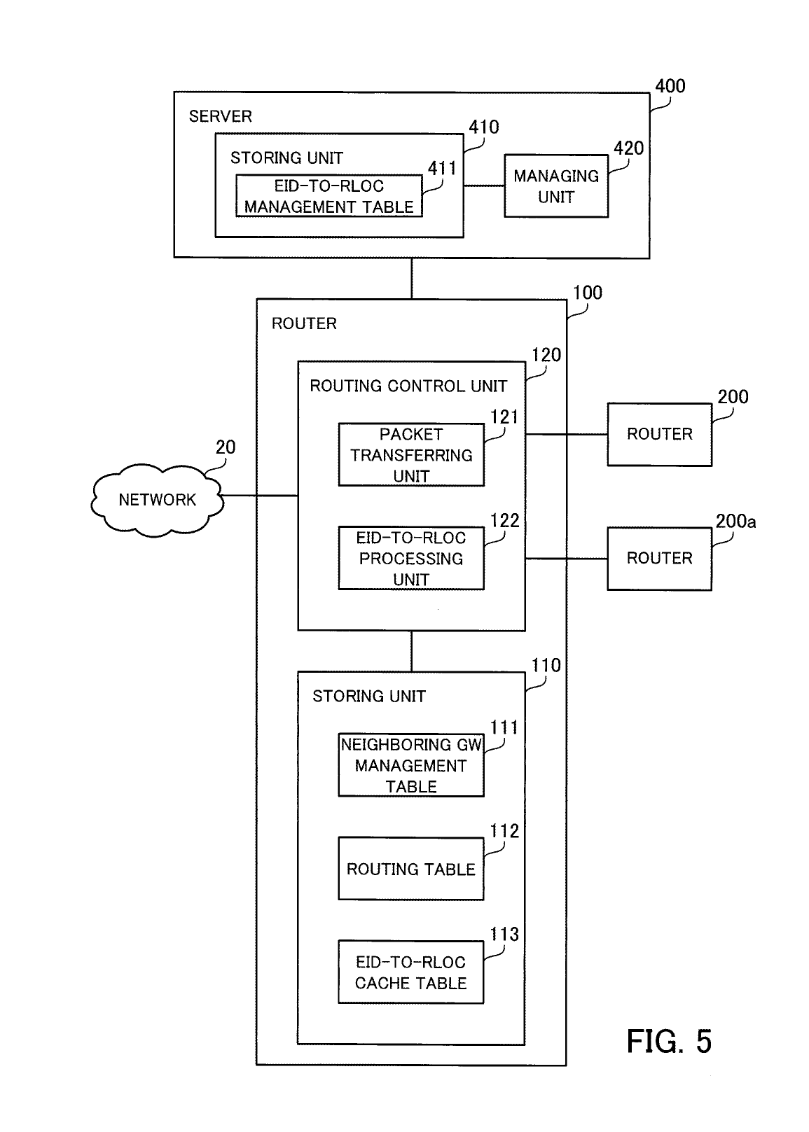

FIG. 5 illustrates an example of software according to the second embodiment. The router 100 includes a storing unit 110 and a routing control unit 120. The storing unit 110 may be implemented using a storage area of the RAM 102. The routing control unit 120 may be implemented by the processor 101 executing a program stored in the RAM 102 or the ROM 103. Alternatively, the routing control unit 120 may be implemented by an electronic circuit, such as an ASIC or FPGA.

The storing unit 110 stores therein a neighboring gateway (GW) management table 111, a routing table 112, and an EID-to-RLOC cache table 113. The neighboring gateway management table 111 is information in which IP addresses of neighboring gateways on the core network 10 side are registered in association with the ports 105c and 105d. According to the example of FIG. 5, the neighboring gateways are the routers 200 and 200a. The neighboring gateway management table 111 may be preliminarily configured, for example, by an administrator. Alternatively, the routing control unit 120 may be caused to acquire the IP addresses of the neighboring gateways using a predetermined protocol and register them. For example, when the router 100 is connected to each of the routers 200 and 200a through a point-to-point protocol (PPP) link, the routing control unit 120 is able to acquire the IP addresses of the routers 200 and 200a using the PPP. The routing table 112 is information in which IP addresses of next-hop routers (hereinafter sometimes referred to as the “next-hop addresses”) are registered in association with destination network addresses. The EID-to-RLOC cache table 113 is information in which a RLOC corresponding to an EID is registered.

The routing control unit 120 includes a packet transferring unit 121 and an EID-to-RLOC processing unit 122. The packet transferring unit 121 transfers packets based on the routing table 112 and the EID-to-RLOC cache table 113 stored in the storing unit 110. For example, the packet transferring unit 121 sends out, from either one of the core network 10-side ports 105c and 105d, a packet having received from the network 20-side port 105a. This means, in other words, that the packet transferring unit 121 transmits the packet having received from the network 20 to either one of the routers 200 and 200a. In this regards, the packet transferring unit 121 encapsulates the packet to be transmitted to the core network 10 using the LISP.

In addition, the packet transferring unit 121 decapsulates encapsulated packets having received from the core network 10-side ports 105c and 105d and then sends out them from the network 20-side port 105a. This means, in other words, that the packet transferring unit 121 transmits, to the network 20 side, the packets obtained by decapsulating the encapsulated packets having received from the routers 200 and 200a.

The EID-to-RLOC processing unit 122 manages mappings between EIDs and RLOCs. For example, the packet transferring unit 121 receives a packet with a destination being the EID of the client 600 from the network 20. The packet is, in other words, addressed to the network 30 because the prefix of the EID is a network address of the network 30. Referring to the EID-to-RLOC cache table 113, the EID-to-RLOC processing unit 122 searches for a RLOC of the corresponding ETR (the router 300). If no RLOC corresponding to the EID is registered in the EID-to-RLOC cache table 113, the EID-to-RLOC processing unit 122 transmits a message requesting for EID-to-RLOC resolution to the server 400. The request for EID-to-RLOC resolution may be simply called “EID-to-RLOC request”. In addition, in the following description, the message may be called “EID-to-RLOC requesting message”. Each EID-to-RLOC requesting message includes IP addresses of the EID and neighboring gateways.

The EID-to-RLOC processing unit 122 receives replies to the request (EID-to-RLOC replies) via the routers 200 and 200a. Based on the EID-to-RLOC replies, the EID-to-RLOC processing unit 122 obtains a RLOC corresponding to the EID. In addition, based on the information included in the EID-to-RLOC replies, the EID-to-RLOC processing unit 122 configures the routing table 112. Further, the EID-to-RLOC processing unit 122 registers a mapping between the EID and the obtained RLOC in the EID-to-RLOC cache table 113.

The server 400 includes a storing unit 410 and a managing unit 420. The storing unit 410 may be implemented using a storage area of the RAM 402 or the HDD 403. The managing unit 420 may be implemented by the processor 401 executing a program stored in the RAM 402 or the HDD 403. Alternatively, the managing unit 420 may be implemented by an electronic circuit, such as an ASIC or FPGA.

The storing unit 410 stores therein an EID-to-RLOC management table 411. The EID-to-RLOC management table 411 is information in which mappings between EIDs and RLOCs are registered. For example, in the EID-to-RLOC management table 411, a mapping between an EID of the client 500 and a RLOC of the router 100 and a mapping between an EID of the client 600 and a RLOC of the router 300 are preliminarily registered. A plurality of clients may be connected to the network 20. In that case, mappings between EIDs of the individual clients and the RLOC of the router 100 are registered in the EID-to-RLOC management table 411. The same applies to the network 30.

The management unit 420 receives an EID-to-RLOC requesting message. Referring to the EID-to-RLOC management table 411, the managing unit 420 searches for a RLOC corresponding to an EID included in the EID-to-RLOC requesting message. The managing unit 420 generates a message instructing to provide the RLOC found in the search and then transmits the message to both the routers 200 and 200a. In the following description, this message is sometimes referred to as the “EID-to-RLOC reply instruction message”. Each EID-to-RLOC reply instruction message includes the RLOC of an ITR having transmitted a corresponding EID-to-RLOC request message and the RLOC of an ETR.

The managing unit 420 preliminarily acquires, from each of the routers 100 and 300, information indicating a mapping between an EID and the IP address of the router 100/300, and then registers the information in the EID-to-RLOC management table 411 stored in the storing unit 410. For example, the management unit 420 preliminarily acquires, from the router 100, information indicating a mapping between the EID of the client 500 placed under the network 20 and a core network 10-side IP address (corresponding to a RLOC) of the router 100 and then registers it in the management table 411. In addition, for example, the management unit 420 preliminarily acquires, from the router 300, information indicating a mapping between the EID of the client 600 placed under the network 30 and a core network 10-side IP address of the router 300 and then registers it in the management table 411.

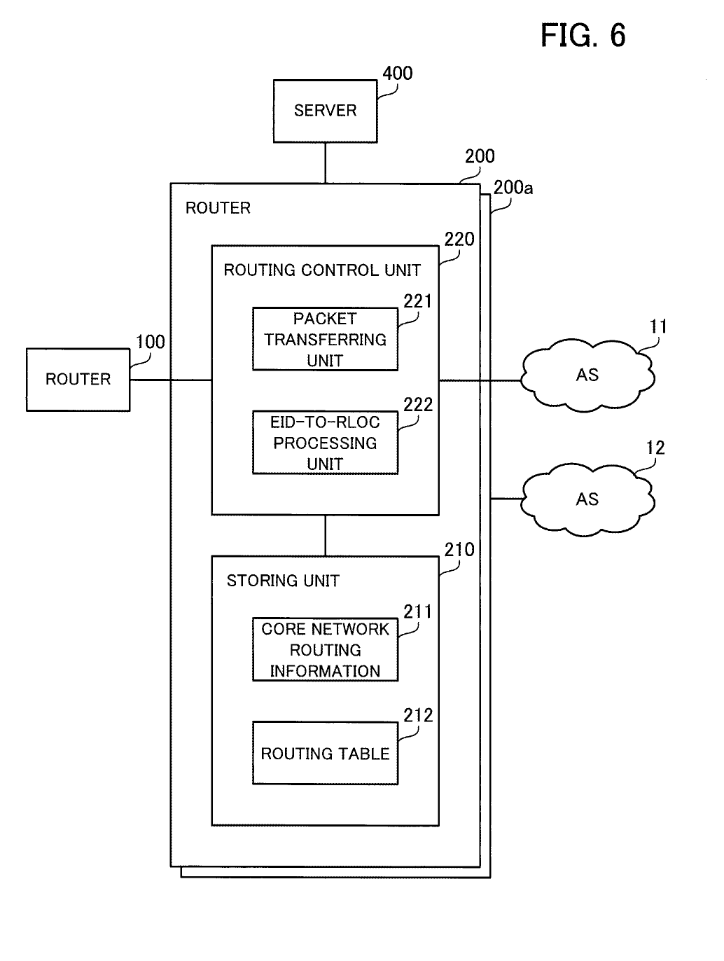

FIG. 6 illustrates the example of software according to the second embodiment, continuing from FIG. 5. The router 200 includes a storing unit 210 and a routing control unit 220. The storing unit 210 may be implemented using a storage area of RAM provided in the router 200. The routing control unit 220 may be implemented by a processor of the router 200 executing a program stored in RAM or ROM provided in the router 200. Alternatively, the routing control unit 220 may be implemented by an electronic circuit, such as an ASIC or FPGA. The router 200a may be implemented using the same software components as the router 200.

The storing unit 210 includes core network routing information 211 and a routing table 212. The core network routing information 211 is routing information of the core network 10, acquired, for example, using BGP. The routing information includes Network Layer Reachability Information (NLRI) (a combination of a destination network address and prefix length) and path attributes. The core network routing information 211 is sometimes referred to as the “BGP table”. For example, a next-hop address (best path) for a destination network address selected based on the core network routing information 211 is advertised to a neighboring router (BGP peer) in the core network 10. Herewith, the routing information is propagated to other routers. The routing table 212 is information in which the best path is set for each network address. The routing control unit 220 may be in charge of information registration in the core network routing information 211 and the routing table 212.

The routing control unit 220 includes a packet transferring unit 221 and an EID-to-RLOC processing unit 222. The packet transferring unit 221 transfers a packet or an encapsulated packet based on the routing table 212 stored in the storing unit 210. For example, the packet transferring unit 221 transmits a packet or an encapsulated packet received from the router 100 to the autonomous system 11 side. In addition, for example, the packet transferring unit 221 transmits a packet or an encapsulated packet received from the autonomous system 11 side to the router 100.

The EID-to-RLOC processing unit 222 receives an EID-to-RLOC reply instruction message. In response, referring to the core network routing information 211 stored in the storing unit 210, the EID-to-RLOC processing unit 222 calculates the distance to the RLOC of the ETR. To be more precise, the distance is the hop count indicating, for example, the number of routers passed to reach the ETR. For example, path attributes associated with the NLRI included in the core network routing information 211 include an AS_PATH attribute indicating autonomous systems to be traversed. For example, based on the AS_PATH attribute, the EID-to-RLOC processing unit 222 may obtain the number of autonomous systems to be traversed to reach the destination network address, and regard the number of autonomous systems as the hop count. This is because the number of autonomous systems to be traversed also represents the distance to the destination network address and is, therefore, usable for evaluating the distance.

As the hop count is larger, processing overhead at routers and the like is more likely to cause a delay in communication, and the hop count may, therefore, be said to indicate the temporal distance. In addition, as the hop count is larger, the length of the line between the ITR and the ETR is more likely to increase, and the hop count may, therefore, be said to indicate the spatial distance. The EID-to-RLOC processing unit 222 transmits a message including the calculated hop count to the router 100. In the following description, the message may be referred to as the “EID-to-RLOC reply message”. The EID-to-RLOC replay message includes the RLOC of the ETR.

Note that the routing control unit 220 advertises a route to the router 100 across the network 10. In the same manner, the router 200a advertises a route to the router 100 across the network 10. Similarly, the router 200b advertises a route to the router 300 across the network 10.

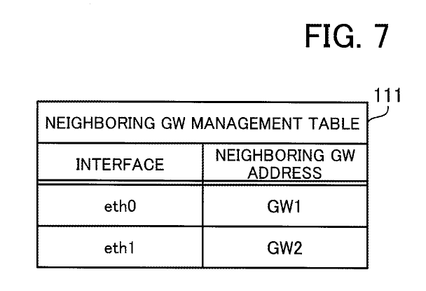

FIG. 7 illustrates an example of a neighboring gateway management table according to the second embodiment. The neighboring gateway management table 111 includes columns of interface and neighboring gateway address. Each field of the interface column contains the identifier to physically identify a port. Each field of the neighboring gateway address column contains the IP address of a corresponding neighboring gateway. For example, an entry with “eth0” in the interface column and “GW1” in the neighboring gateway address column is registered in the neighboring gateway management table 111. “eth0” is the identifier of the port 105c. “GW1” is the IP address of the router 200. That is, the entry indicates that the router 200 is connected through the port 105c. Similarly, “eth1” is the identifier of the port 105d and “GW2” is the IP address of the router 200a.

Further, IP addresses of other apparatuses are as follows: the router 100 has a core network 10-side IP address of “RLOC1”; the router 300 has a core network 10-side IP address of “RLOC2”; the server 400 has an IP address of “SV1”; the client 500 has an IP address of “IP1”; and the client 600 has an IP address of “IP2”.

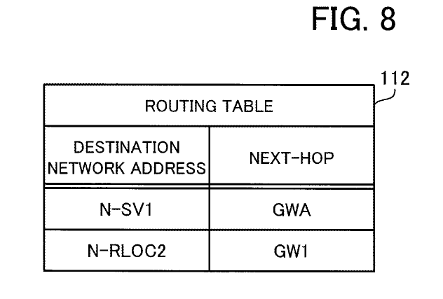

FIG. 8 illustrates an example of a routing table according to the second embodiment. The routing table 112 includes columns of destination network address and next-hop. Each field in the destination network address column contains a destination network address. Each field in the next-hop column contains a corresponding next-hop address. For example, an entry with “N-SV1” in the destination network address column and “GWA” in the next-hop column is registered in the routing table 112. “N-SV1” is the network address of the autonomous system 14. “GWA” is the IP address of a router connected to the autonomous system 14 (i.e., a router connected through the port 105b). That is, the entry indicates that the port 105b is used to send out a packet to the server 400. In addition, according to the example of FIG. 8, an entry with “N-RLOC2” in the destination network address column and “GW1” in the next-hop column is registered in the routing table 112. “N-RLOC2” is a core network 10-side network address of the router 300. That is, the entry indicates that the port 105c is used to send out a packet (an encapsulated packet) to the router 300.

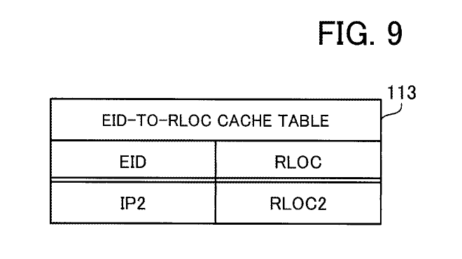

FIG. 9 illustrates an example of an EID-to-RLOC cache table according to the second embodiment. The EID-to-RLOC cache table 113 includes columns of EID and RLOC. Each field in the EID column contains an EID. Each field in the RLOC column contains a corresponding RLOC. For example, an entry with “IP2” in the EID column and “RLOC2” in the RLOC column is registered in the EID-to-RLOC cache table 113. The entry indicates that an ETR corresponding to the client 600 is the router 300. That is, the entry indicates that, in transferring a packet to the client 600, a header including the router 300 as its destination needs to be added to the packet (this process is called “packet encapsulation”).

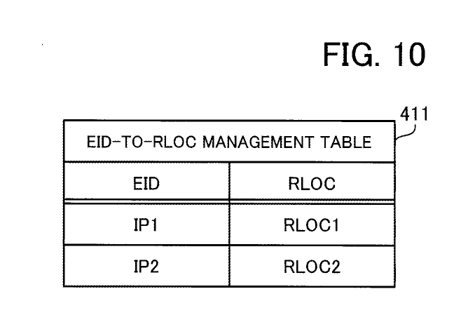

FIG. 10 illustrates an example of an EID-to-RLOC management table according to the second embodiment. The EID-to-RLOC management table 411 includes columns of EID and RLOC. Each field in the EID column contains an EID. Each field in the RLOC column contains a corresponding RLOC. For example, an entry with “IP1” in the EID column and “RLOC1” in the RLOC column is registered in the EID-to-RLOC management table 411. The entry indicates that an ETR corresponding to the client 500 is the router 100. In addition, according to the example of FIG. 10, an entry with “IP2” in the EID column and “RLOC2” in the RLOC column is registered in the EID-to-RLOC management table 411. The entry indicates that an ETR corresponding to the client 600 is the router 300.

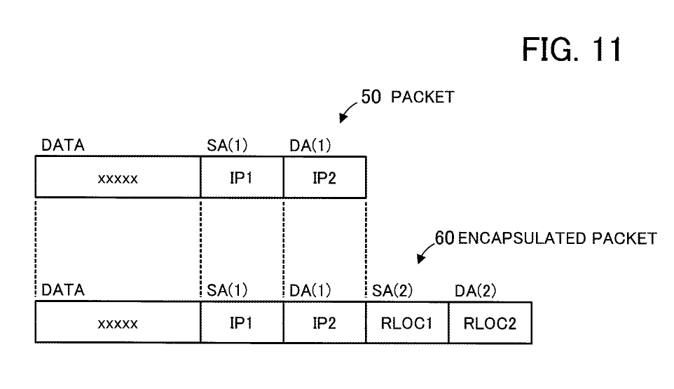

FIG. 11 illustrates an example of packets according to the second embodiment. A packet 50 includes fields of destination address (DA) (1), source address (SA) (1), and DATA. The DA(1) field contains a destination address. The SA(1) field contains a transmission source address. The DATA field contains the essential data (payload) to be transmitted. Predetermined field groups including the DA(1) and SA(1) fields form a header. For example, the router 100 may receive the packet 50 with “IP2” in the DA(1) field, “IP1” in the SA(1) field, and “xxxxx” in the DATA field.

An encapsulated packet 60 includes fields of DA(2), SA(2), DA(1), SA(1), and DATA. The DA(2) field contains a destination address in the core network 10. The SA(2) field contains a transmission source address in the core network 10. The DA(1), SA(1), and DATA fields are the same as those of the packet 50. For example, the router 100 may encapsulate the packet 50 to form and then transmit the encapsulated packet 60 with “RLOC2” in the DA(2) field, “RLOC1” in the SA(2) field, “IP2” in the DA(1) field, “IP1” in the SA(1) filed, and “xxxxx” in the DATA field. The encapsulated packet 60 is then transferred by routers inside the core network 10 based on the IP address set in the DA(2) field.

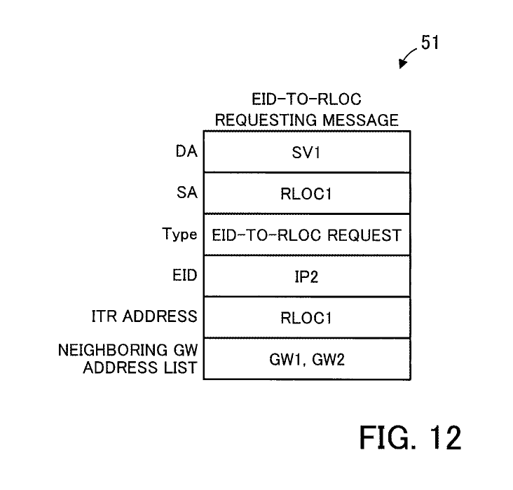

FIG. 12 illustrates an example of an EID-to-RLOC requesting message according to the second embodiment. An EID-to-RLOC requesting message 51 includes the following fields: destination address (DA); source address (SA); type; EID; ITR address; and neighboring gateway address list. The destination address and source address fields are comparable to the DA(1) and SA(1) fields of the packet 50. The type field contains an attribute of the message. The EID field contains an EID. The ITR address field contains the IP address of an ITR issuing the EID-to-RLOC requesting message 51. The neighboring gateway address list field includes IP addresses of core network 10-side neighboring gateways of the ITR.

For example, when the router 100 has received, from the client 500, a packet with a destination address being the client 600, the EID-to-RLOC requesting message 51 is configured as follows. The destination address field contains “SV1” because the EID-to-RLOC requesting message 51 is addressed to the server 400. The source address field contains “RLOC1” because the transmission source is the router 100. The type field contains “EID-to-RLOC request” because the EID-to-RLOC requesting message 51 is an EID-to-RLOC requesting message. The EID field contains “IP2” because the router 100 needs to transfer the packet addressed to the client 600. The ITR address field contains “RLOC1” because the requestor is the router 100. The neighboring gateway address list field contains “GW1, GW2” because they are registered in the neighboring gateway management table 111.

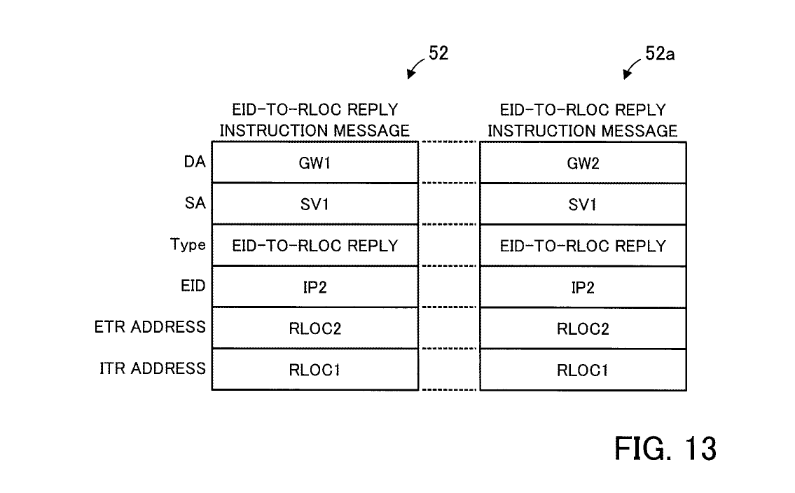

FIG. 13 illustrates an example of EID-to-RLOC reply instruction messages according to the second embodiment. Each of EID-to-RLOC reply instruction messages 52 and 52a includes the following fields: destination address (DA); source address (SA); type; EID; ETR address; and ITR address. Contents set in the destination address, source address, type, EID, and ITR address fields are the same as those described in relation to the EID-to-RLOC requesting message 51. The ETR address field contains a RLOC corresponding to the EID. For example, the EID-to-RLOC reply instruction messages 52 and 52a to be transmitted by the server 400 in response to the EID-to-RLOC requesting message 51 are configured as follows.

As for the EID-to-RLOC reply instruction message 52, the destination address field contains “GW1” because, in the EID-to-RLOC requesting message 51, “GW1, GW2” are designated in the neighboring gateway address list field and the EID-to-RLOC reply instruction message 52 is a message addressed to the router 200. The source address field contains “SV1” because the transmission source is the server 400. The type field contains “EID-to-RLOC replay” because the EID-to-RLOC reply instruction message 52 is an EID-to-RLOC reply instruction message. Note that since an EID-to-RLOC reply instruction message is transmitted in response to an EID-to-RLOC requesting message, it may also be referred to as the “EID-to-RLOC reply message”. In this example, the term “EID-to-RLOC reply instruction message” is used for reasons of expediency in order to distinguish it from EID-to-RLOC reply messages transmitted by the routers 200 and 200a. The EID field contains “IP2” because, in the EID-to-RLOC requesting message 51, “IP2” is designated in the EID field. The ETR address field contains “RLOC2” because a RLOC corresponding to the EID “IP2” is “RLOC2”. The ITR address field contains “RLOC1” because the requestor is the router 100.

As for the EID-to-RLOC reply instruction message 52a, the destination address field contains “GW2” because, in the EID-to-RLOC requesting message 51, “GW1, GW2” are designated in the neighboring gateway address list field and the EID-to-RLOC reply instruction message 52a is a message addressed to the router 200a. Contents set in the remaining fields are the same as those of the EID-to-RLOC reply instruction message 52.

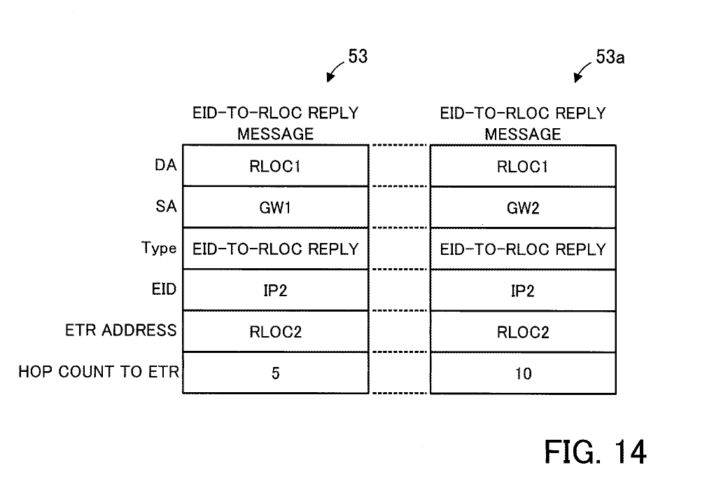

FIG. 14 illustrates an example of EID-to-RLOC reply messages according to the second embodiment. Each of EID-to-RLOC reply messages 53 and 53a includes the following fields: destination address (DA); source address (SA); type; EID; ETR address; and hop count to ETR. Contents set in the destination address, source address, type, EID, and ETR address fields are the same as those described in relation to the EID-to-RLOC reply instruction messages 52 and 52a. The hop count to ETR field contains the hop count between each router having received the EID-to-RLOC reply instruction message 52/52a and the ETR. For example, the EID-to-RLOC replay messages 53 and 53a issued in response to the EID-to-RLOC reply instruction messages 52 and 52a, respectively, are configured as follows.

As for the EID-to-RLOC reply message 53, the destination address field contains “RLOC1” because the EID-to-RLOC reply message 53 is addressed to the router 100. The source address field contains “GW1” because the transmission source is the router 200. The type field contains “EID-to-RLOC reply” because the EID-to-RLOC reply message 53 is an EID-to-RLOC reply message. The EID field contains “IP2” because, in the EID-to-RLOC reply instruction message 52, “IP2” is designated in the EID field. The ETR address is “RLOC2” because, in the EID-to-RLOC reply instruction message 52, “RLOC2” is designated in the ETR address field. The hop count to the ETR is “5”, which is calculated by the router 200 based on the core network routing information 211.

As for the EID-to-RLOC reply message 53a, the source address field contains “GW2” because the EID-to-RLOC reply message 53a is addressed to the router 200a. The hop count to the ETR is “10”, which is calculated by the router 200a based on core network routing information held by the router 200a. Contents set in the remaining fields are the same as those of the EID-to-RLOC reply message 53.

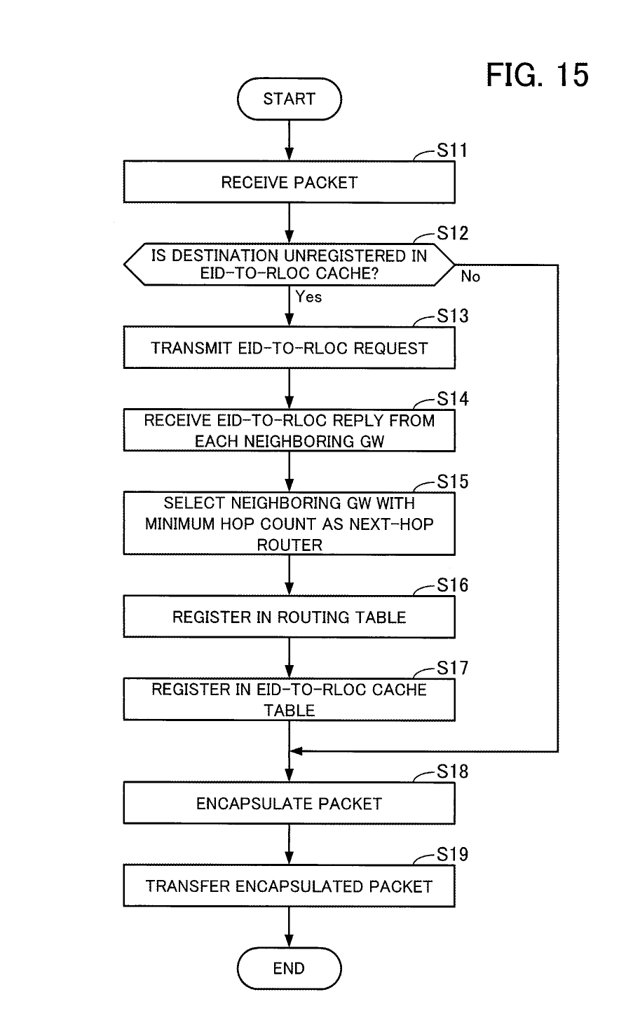

FIG. 15 is a flowchart illustrating an example of processing carried out by an ITR according to the second embodiment. The process of FIG. 15 is described next according to the step numbers in the flowchart. In FIG. 15 and the following diagrams, the word “message” is sometimes omitted.

[Step S11] The packet transferring unit 121 receives the packet 50. The DA(1) and SA(1) (i.e., EIDs) fields of the packet 50 contain “IP2” and “IP1”, respectively.

[Step S12] The EID-to-RLOC processing unit 122 determines whether the EID “IP2” is unregistered in the EID-to-RLOC cache table 113. If it is unregistered, the process proceeds to step S13. On the other hand, if it has been registered, the process proceeds to step S18.

[Step S13] Referring to the neighboring gateway management table 111 stored in the storing unit 110, the EID-to-RLOC processing unit 122 acquires IP addresses of the neighboring gateways (the routers 200 and 200a). The EID-to-RLOC processing unit 122 generates the EID-to-RLOC requesting message 51 including the IP addresses of the neighboring gateways (the neighboring gateway address list) and transmits the EID-to-RLOC requesting message 51 to the server 400.

[Step S14] The EID-to-RLOC processing unit 122 receives, from the router 200, the EID-to-RLOC reply message 53 in response to the EID-to-RLOC requesting message 51. In addition, the EID-to-RLOC processing unit 122 receives, from the router 200a, the EID-to-RLOC reply message 53a in response to the EID-to-RLOC requesting message 51.

[Step S15] Based on the EID-to-RLOC reply messages 53 and 53a, the EID-to-RLOC processing unit 122 selects, between the routers 200 and 200a, one having the minimum hop count as a next-hop router. According to the example of the EID-to-RLOC reply messages 53 and 53a, the hop count set in the EID-to-RLOC reply message 53 is “5”, which is smaller than the hop count “10” set in the EID-to-RLOC reply message 53a. Therefore, the hop count set in the EID-to-RLOC reply message is the minimum hop count. As a result, the EID-to-RLOC processing unit 122 selects the router 200 as the next-hop router.

[Step S16] The EID-to-RLOC processing unit 122 adds an entry to the routing table 112 based on the EID-to-RLOC reply message received from the neighboring gateway having been selected as the next-hop router. For example, the EID-to-RLOC processing unit 122 registers, in the routing table 112, a network address “N-RLOC2” of the ETR address “RLOC2” included in the EID-to-RLOC reply message 53 in association with the IP address “GW1” of the router 200. Note that the entry may have already been registered in the routing table 112. In this case, the process may skip step S16.

[Step S17] The EID-to-RLOC processing unit 122 adds an entry to the EID-to-RLOC cache table 113 based on the EID-to-RLOC reply message received from the neighboring gateway having been selected as the next-hop router. For example, the EID-to-RLOC processing unit 122 registers, in the EID-to-RLOC cache table 113, the EID “IP2” included in the EID-to-RLOC reply message 53 in association with the ETR address “RLOC2”.

[Step S18] Referring to the EID-to-RLOC cache table 113, the packet transferring unit 121 acquires the RLOC “RLOC2” corresponding to the EID “IP2”. The packet transferring unit 121 encapsulates the packet 50 to generate the encapsulated packet 60. The DA(2) and SA(2) fields of the encapsulated packet 60 contain “RLOC2” and “RLOC1”, respectively.

[Step S19] The packet transferring unit 121 transfers the encapsulated packet 60. Specifically, referring to the routing table 112, the packet transferring unit 121 acquires the next-hop address “GW1” corresponding to the network address “N-RLOC2” of the RLOC “RLOC2”. Therefore, the packet transferring unit 121 sends out the encapsulated packet 60 from the port 105c connected to the router 200.

Thus, when there is an EID not registered in the EID-to-RLOC cache table 113, the router 100 transmits the EID-to-RLOC requesting message 51 to the server 400, to thereby resolve a corresponding RLOC. Specifically, the router 100 receives the EID-to-RLOC reply messages 53 and 53a including hop counts to the ETR (the router 300). The router 100 obtains the RLOC and determines a next-hop address based on the hop counts.

Note that the EID-to-RLOC processing unit 122 proceeds to step S15 after, in step S14, normally receiving as many EID-to-RLOC reply messages 53 and 53a as the number of neighboring gateway IP addresses included in the EID-to-RLOC requesting message 51 (in this example, two). Note however that there are some cases where only one EID-to-RLOC reply message is received due to, for example, a network failure (for example, the case where a reply message is destroyed on the way or the case where only one reply message is received within a predetermined time limit due to, for example, delay). In such a case, the process may skip Step S15 and proceed to step S16. In this regard, the EID-to-RLOC processing unit 122 is able to conduct processing from step S16 onward based on the ETR address and the like included in the received EID-to-RLOC reply message.

In addition, as mentioned in step S17, mappings between resolved RLOCs and EIDs are held in the EID-to-RLOC cache table 113. Herewith, after this point in time, omission of steps S13 to S17 is possible when the determination in step S12 is “NO”.

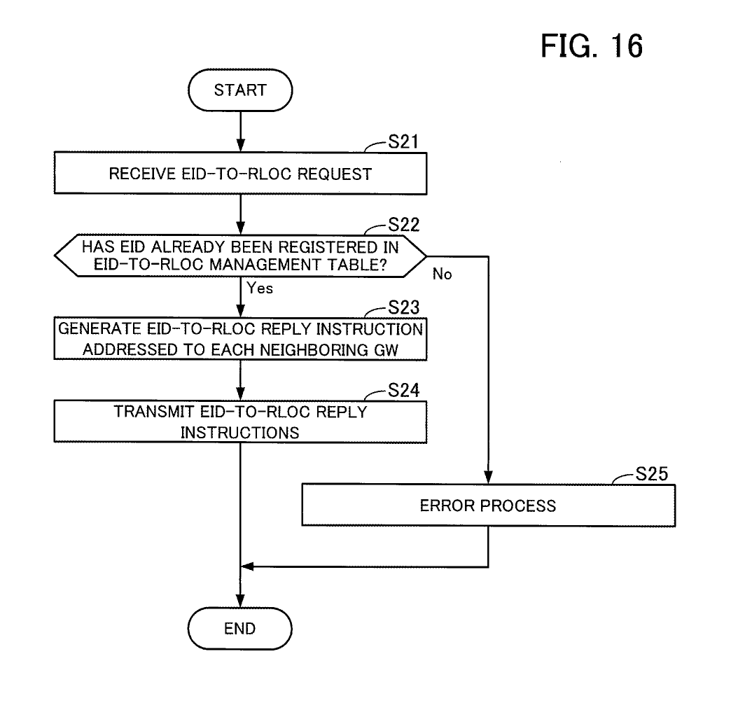

FIG. 16 is a flowchart illustrating an example of processing carried out by a server according to the second embodiment. The process of FIG. 16 is described next according to the step numbers in the flowchart.

[Step S21] The managing unit 420 receives the EID-to-RLOC requesting message 51 from the router 100. The managing unit 420 acquires the EID “IP2” from the EID-to-RLOC requesting message 51.

[Step S22] Referring to the EID-to-RLOC management table 411, the managing unit 420 determines whether the EID “IP2” has already been registered. If it has already been registered, the process proceeds to step S23. On the other hand, if it is not registered, the process proceeds to step S25.

[Step S23] The managing unit 420 acquires the RLOC “RLOC2” corresponding to the EID “IP2” from the EID-to-RLOC management table 411. The managing unit 420 acquires IP addresses of neighboring gateways from the EID-to-RLOC requesting message 51. Based on the acquired information, the managing unit 420 generates the EID-to-RLOC reply instruction messages 52 and 52a. Each of the EID-to-RLOC reply instruction messages 52 and 52a includes the ITR address “RLOC1” and the ETR address “RLOC2”. The EID-to-RLOC reply instruction message is addressed to the router 200. The EID-to-RLOC reply instruction message 52a is addressed to the router 200a.

[Step S24] The managing unit 420 transmits the EID-to-RLOC reply instruction message 52 to the router 200. The managing unit 420 also transmits the EID-to-RLOC reply instruction message 52a to the router 200a. Then, the managing unit 420 ends the process.

[Step S25] The managing unit 420 conducts an error process. For example, the managing unit 420 informs the router 100 of the absence of a corresponding EID (error reply). Based on the error reply, the router 100 may inform the client 600 of the impossibility of transferring the packet to the EID. Then, the managing unit 420 ends the process.

In this manner, in response to the EID-to-RLOC requesting message 51, the server 400 transmits the EID-to-RLOC reply instruction messages 52 and 52a to the routers 200 and 200a, respectively.

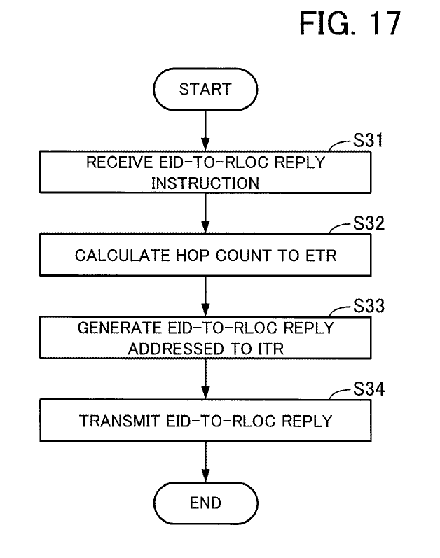

FIG. 17 is a flowchart illustrating an example of processing carried out by a network core router according to the second embodiment. The process of FIG. 17 is described next according to the step numbers in the flowchart. Although the following description takes processing of the router 200 as an example, the router 200a also goes through a similar process.

[Step S31] The EID-to-RLOC processing unit 222 receives the EID-to-RLOC reply instruction message 52 from the server 400. The EID-to-RLOC processing unit 222 acquires the ETR address “RLOC2” from the EID-to-RLOC reply instruction message 52.

[Step S32] The EID-to-RLOC processing unit 222 calculates the hop count between the router 200 and the router 300 (“RLOC2”) functioning as the ETR based on the core network routing information 211 stored in the storing unit 210. In this regards, a plurality of routes may be available between the routers 200 and 300. In such a case, a route with the minimum hop count is adopted. This is with the purpose of cutting the processing costs of the router 100 by reducing the number of options presented to the router 100.

[Step S33] The EID-to-RLOC processing unit 222 acquires the ITR address “RLOC1” from the EID-to-RLOC reply instruction message 52, and generates the EID-to-RLOC reply message 53 addressed to the router 100. The EID-to-RLOC reply message 53 includes “RLOC2” in the ETR address field and “5” in the hop count to ETR field.

[Step S34] The EID-to-RLOC processing unit 222 transmits the EID-to-RLOC reply message 53 to the router 100.

Thus, based on the EID-to-RLOC reply instruction message 52, the router 200 generates the EID-to-RLOC reply message 53 and transmits it to the router 100. In this regard, the router 200 calculates the hop count between the router 200 and the router 300 functioning as the ETR and includes the hop count in the EID-to-RLOC reply message 53. Note however that a predetermined value (for example, 1) common to the routers 200 and 200a may be added to the calculated hop count. Alternatively, the calculated hop count may be weighted for each router (for example, the calculated hop count is multiplied by a coefficient different for each router).

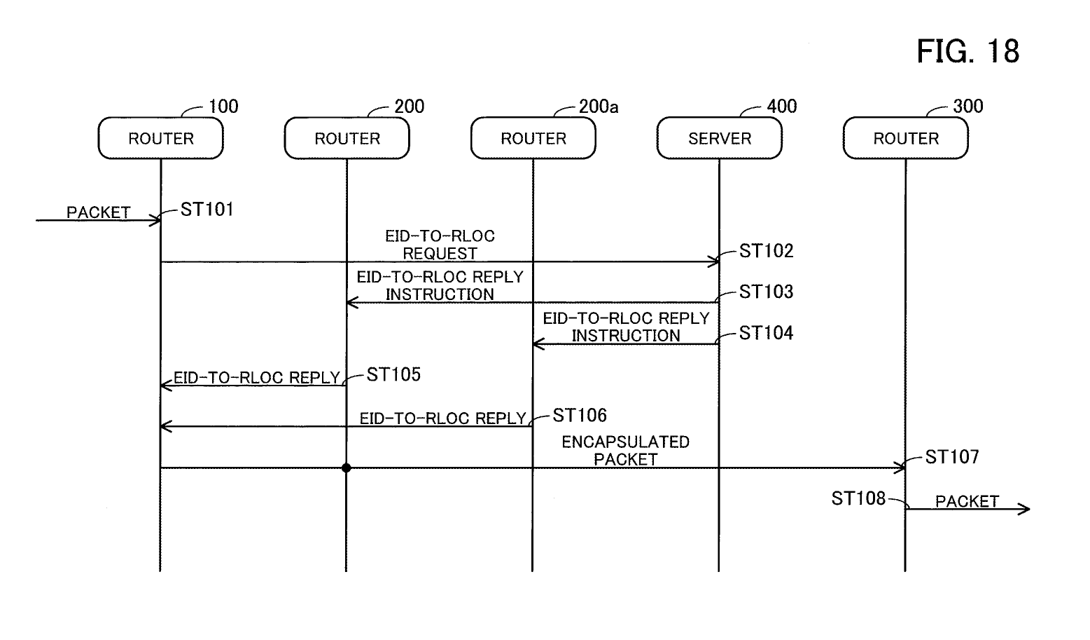

FIG. 18 is a sequence diagram illustrating a processing example according to the second embodiment. The process of FIG. 18 is described next according to the step numbers in the flowchart. The router 100 receives, from the client 500, the packet 50 addressed to the client 600 (step ST101). If the EID “IP2” of the client 600 is unregistered in the EID-to-RLOC cache table 113, the router 100 generates the EID-to-RLOC requesting message 51. The router 100 transmits the EID-to-RLOC requesting message 51 to the server 400 (step ST102).

Upon receiving the EID-to-RLOC requesting message 51, the server 400 refers to the EID-to-RLOC management table 411 to search for an entry of the EID “IP2” and then acquires the corresponding RLOC “RLOC2”. The server 400 generates the EID-to-RLOC reply instruction messages 52 and 52a. The server 400 transmits the EID-to-RLOC reply instruction message 52 to the router 200 (step ST103). The server 400 transmits the EID-to-RLOC reply instruction message 52a to the router 200a (step ST104). Steps ST103 and ST104 may be executed simultaneously, or their order of execution may be switched around.

Upon receiving the EID-to-RLOC reply instruction message 52, the router 200 calculate the hop count between the routers 200 and 300 and then generates the EID-to-RLOC reply message 53. The router 200 transmits the EID-to-RLOC reply message 53 to the router 100 (Step ST105). Upon receiving the EID-to-RLOC reply instruction message 52a, the router 200a calculate the hop count between the routers 200a and 300 and then generates the EID-to-RLOC reply message 53a. The router 200a transmits the EID-to-RLOC reply message 53a to the router 100 (Step ST106). Steps ST105 and ST106 may be executed simultaneously, or their order of execution may be switched around.

Upon receiving the EID-to-RLOC reply messages 53 and 53a, the router 100 compares their hop counts to the ETR. The router 100 selects the router 200 with the minimum hop count as the next-hop router. Based on the selection result, the router 100 registers a new entry in each of the routing table 112 and the EID-to-RLOC cache table 113. The router 100 encapsulates the packet 50 to generate the encapsulated packet 60, which is then transmitted to the router 300. In this regard, the encapsulated packet 60 is transmitted from the port 105c. The encapsulated packet 60 goes through the router 200 to then reach the router 300 (step ST107). Upon receiving the encapsulated packet 60, the router 300 decapsulates the encapsulated packet 60 to obtain the packet 50. The router 300 transfers the packet 50 to the client 600 (step ST108).

In the above-described manner, the router 100 obtains the hop counts between each of the routers 200 and 200a and the router 300. The router 100 compares these hop counts to select one of the routers 200 and 200a as the next-hop router. Therefore, the router 100 need not participate in EGP (for example, BGP) of the core network 10. As a result, the router 100 does not have to collect core network routing information. Note however that the router 100 may collect routing information of the network 20 to thereby select a route in the network 20.

For example, the routers 200 and 200a control the core network routing information not to be advertised to the router 100. Alternatively, even when receiving the core network routing information from the router 200 or 200a, the router 100 discards the information. With this, the router 100 is able to save an area within the RAM 102 or the like, used for the routing control. In addition, this also contributes a reduction in the processing costs of the router 100 to evaluate route selection indexes.

Especially, in providing xTRs on the responsibility of the network 20 side, it may be difficult to provide ones corresponding to a large-scale network like the core network 10. This is because, for example, relatively high-performance routers corresponding to a large-scale network are sometimes very expensive. However, even when the processing performance of the router 100 or the capacity of the RAM 102 is relatively low, the second embodiment produces an increased potential for attaining desired processing performance. That is, the second embodiment is able to reduce the level of processing performance called for the router 100 and therefore has a large cost advantage.

The LISP allows the next-hop router to be selected along with the ETR address resolution. Therefore, it is possible to more efficiently select the next-hop router than the case of sending a dedicated packet to select the next-hop router.

### (c) Third Embodiment

Next described is a third embodiment. The following focuses mainly on features different from those described in the previous second embodiment while omitting description of common features. According to the second embodiment, the server 400 transmits the EID-to-RLOC reply instruction messages 52 and 52a to the routers 200 and 200a, respectively. On the other hand, according to the third embodiment, the server 400 transmits an EID-to-RLOC reply instruction message to the ETR so that the ITR is able to select a next-hop router.

Here, the information processing system of the third embodiment is the same as that of the second embodiment illustrated in FIG. 2. Hardware and software examples of the third embodiment are the same as those of the second embodiment illustrated in FIGS. 3 to 6. Therefore, the same names and reference numerals as those in the second embodiment are given to the same devices in the third embodiment. Note however that the third embodiment differs from the second embodiment in that the managing unit 420 transmits an EID-to-RLOC reply instruction message to the router 300 functioning as the ETR. In addition, the router 200 of the third embodiment need not have the EID-to-RLOC processing unit 222 (the same applies to the router 200a). Further, the third embodiment differs from the second embodiment in that the EID-to-RLOC processing unit 122 of the router 100 functioning as the ITR selects a next-hop router based on EID-to-RLOC reply messages transferred from the router 300.

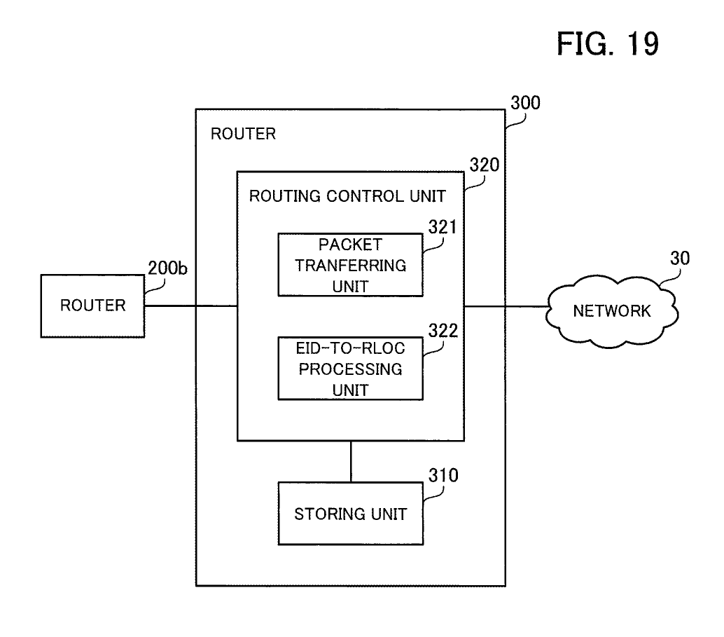

FIG. 19 illustrates an example of software of an ETR according to the third embodiment. The router 300 includes a storing unit 310 and a routing control unit 320. The storing unit 310 may be implemented using a storage area of RAM provided in the router 300. The routing control unit 320 may be implemented by a processor of the router 300 executing a program stored in RAM or ROM provided in the router 300. Alternatively, the routing control unit 320 may be implemented by an electronic circuit, such as an ASIC or FPGA.

The storing unit 310 stores therein data to be used by the routing control unit 320 for its processing. For example, the storing unit 310 stores various types of information used when the router 300 functions as an ITR. Specifically, the storing unit 310 stores a neighboring gateway management table, a routing table, and an EID-to-RLOC cache table, as with the storing unit 110.

The routing control unit 320 includes a packet transferring unit 321 and an EID-to-RLOC processing unit 322. The packet transferring unit 321 transfers a packet based on the routing table stored in the storing unit 310. For example, the packet transferring unit 321 decapsulates an encapsulated packet received from the router 200b using the LISP and then transmits the decapsulated packet to the network 30. In addition, for example, the packet transferring unit 321 encapsulates a packet received from the network 30 using the LISP and then transmits the encapsulated packet to the router 200b.

The EID-to-RLOC processing unit 322 receives an EID-to-RLOC reply instruction message from the server 400. Based on the EID-to-RLOC reply instruction message, the EID-to-RLOC processing unit 322 generates EID-to-RLOC reply messages addressed to individual interfaces of the router 100. That is, the EID-to-RLOC processing unit 322 generates as many EID-to-RLOC reply messages as the number of interfaces provided in the router 100. At this time, the EID-to-RLOC processing unit 322 includes the same TTL value in each of the EID-to-RLOC reply messages. The EID-to-RLOC processing unit 322 transmits the individual EID-to-RLOC reply messages.

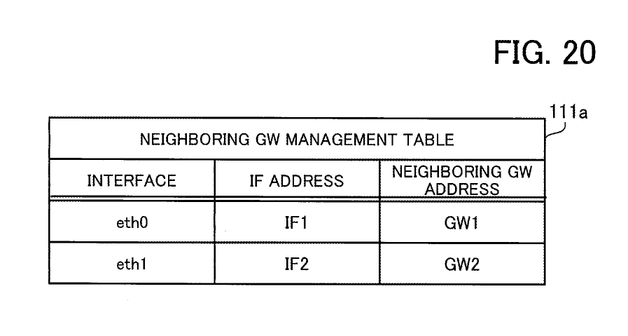

FIG. 20 illustrates an example of a neighboring gateway management table according to the third embodiment. A neighboring gateway management table 111a is stored in the storing unit 110, in place of the neighboring gateway management table 111. The neighboring gateway management table 111a includes columns of interface, interface (IF) address, and neighboring gateway address. Each field in the interface column contains the identifier to physically identify a port. Each field in the interface address column contains the IP address of a corresponding interface. Each field in the neighboring gateway address contains the IP address of a corresponding neighboring gateway. For example, an entry with “eth0” in the interface column, “IF1” in the interface address column, and “GW1” in the neighboring gateway address column is registered in the neighboring gateway management table 111a. That is, the entry indicates that the IP address of an interface corresponding to the port 105c is “IF1” and the router 200 is connected through the port 105c. Note that “IF2” is the IP address of an interface corresponding to the port 105d.

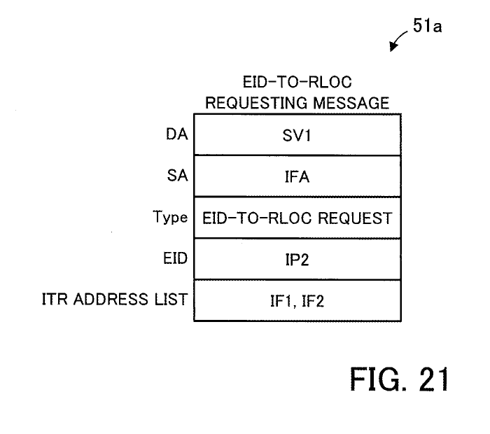

FIG. 21 illustrates an example of an EID-to-RLOC requesting message according to the third embodiment. An EID-to-RLOC requesting message 51a is generated by the EID-to-RLOC processing unit 122, in place of the EID-to-RLOC requesting message 51. The EID-to-RLOC requesting message 51a includes the following fields: destination address (DA); source address (SA); type; EID; and ITR address list. Contents set in the destination address, source address, type, and EID fields are the same as those described in relation to the EID-to-RLOC requesting message 51.

The ITR address list field includes IP addresses of interfaces provided in the ITR, connected to neighboring gateways. For example, when the router 100 has received, from the client 500, a packet with a destination address being the client 600, the EID-to-RLOC requesting message 51a is configured as follows. The destination address field contains “SV1” because the EID-to-RLOC requesting message 51a is addressed to the server 400. The source address field contains “IFA” because the transmission source is the port 105b. “IFA” is the IP address of an interface corresponding to the port 105b. The type field contains “EID-to-RLOC request” because the EID-to-RLOC requesting message 51a is an EID-to-RLOC requesting message. The EID field contains “IP2” because the router 100 needs to transfer the packet addressed to the client 600. The ITR address list field contains “IF1, IF2” because they are registered in the neighboring gateway management table 111a as interface addresses corresponding to the neighboring gateways.

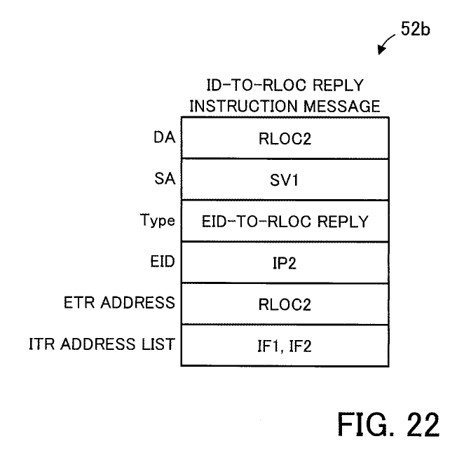

FIG. 22 illustrates an example of an EID-to-RLOC reply instruction message according to the third embodiment. An EID-to-RLOC reply instruction message 52b is generated by the managing unit 420, in place of the EID-to-RLOC reply instruction messages 52 and 52a. The EID-to-RLOC reply instruction message 52b includes the following fields: destination address (DA); source address (SA); type; EID; ETR address; and ITR address list. Contents set in the destination address, source address, type, EID, and ETR address fields are the same as those described in relation to the EID-to-RLOC reply instruction messages 52 and 52a. Contents set in the ITR address list field are the same as those described in relation to the EID-to-RLOC requesting message 51a. For example, the EID-to-RLOC reply instruction message 52b to be transmitted by the server 400 in response to the EID-to-RLOC requesting message 51a is configured as follows.

The destination address field contains “RLOC2” because the EID-to-RLOC reply instruction message 52b is addressed to the router 300 functioning as the ETR. The source address field contains “SV1” because the transmission source is the server 400. The type field contains “EID-to-RLOC reply” because the EID-to-RLOC reply instruction message 52b is an EID-to-RLOC reply instruction message. The EID field contains “IP2” because the EID “IP2” has been designated in the EID-to-RLOC requesting message 51a. The ETR address field contains “RLOC2” because a RLOC corresponding to the EID “IP2” is “RLOC2”. The ITR address list field contains “IF1, IF2” because the ITR address list “IF1, IF2” has been designated in the EID-to-RLOC requesting message 51a.

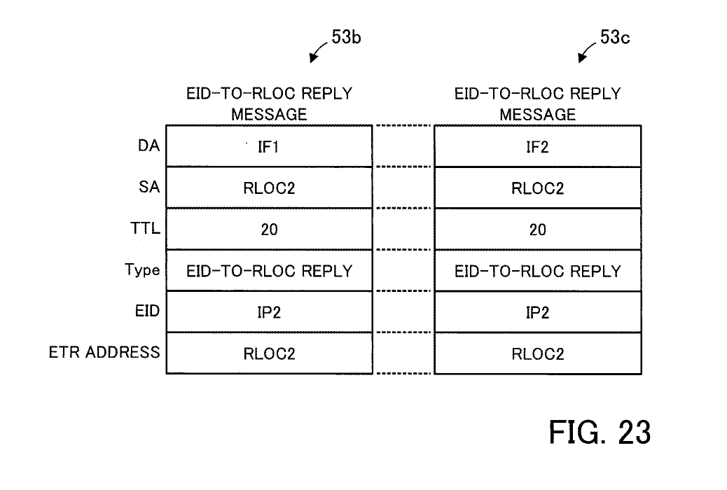

FIG. 23 illustrates an example of EID-to-RLOC reply messages according to the third embodiment. Each of EID-to-RLOC reply messages 53b and 53c includes the following fields: destination address (DA); source address (SA); TTL; type; EID; and ETR address. Contents set in the destination address, source address, type, EID and ETR address fields are the same as those described in relation to the EID-to-RLOC reply messages 53 and 53a. The TTL is a parameter allowed to be set in the packet. The value of the TTL is subtracted by 1 for each hop to a router. When the TTL value has reached 0, the packet is destroyed. Note that, in IPv6, information corresponding to the TTL is sometimes referred to as “hop limit”. The EID-to-RLOC reply messages 53b and 53c in response to the EID-to-RLOC reply instruction message 52b are configured as follows, for example.

As for the EID-to-RLOC reply message 53b, the destination address field contains “IF1” because the EID-to-RLOC reply message 53b is addressed to the port 105c of the router 100. The source address field contains “RLOC2” because the transmission source is the router 300. The TTL field contains a value of “20” which is preliminarily designated. The type field contains “EID-to-RLOC replay” because the EID-to-RLOC reply message 53b is an EID-to-RLOC reply message. The EID field contains “IP2” because the EID “IP2” has been designated in the EID-to-RLOC reply instruction message 52b. The ETR address field contains “RLOC2” because the ETR address “RLOC2” has been designated in the EID-to-RLOC reply instruction message 52b. Since “IF1” is set as the destination address, the EID-to-RLOC reply message 53b goes through the router 200 to reach the router 100.

As for the EID-to-RLOC reply message 53c, the destination address field contains “IF2” because the EID-to-RLOC reply message 53c is addressed to the port 105d of the router 100. Contents set in the remaining fields are the same as those of the EID-to-RLOC reply message 53b at the time of being sent out from the router 300. Note however that the values in the TTL fields of the EID-to-RLOC reply messages 53b and 53c may be different at the time of arrival at the router 100 according to their hop counts to the router 100. Since “IF2” is set as the destination address, the EID-to-RLOC reply message 53c goes through the router 200a to reach the router 100.

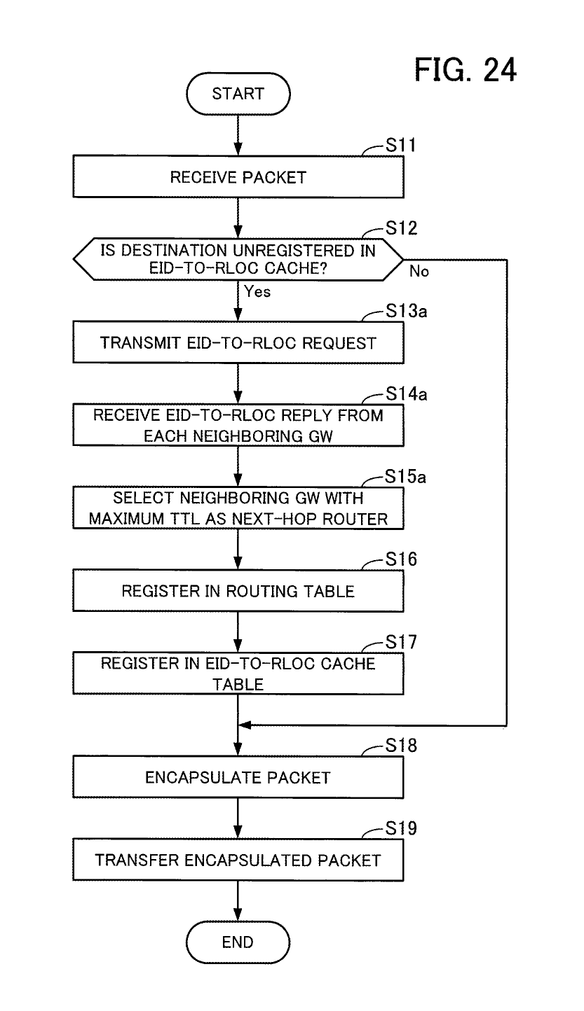

FIG. 24 is a flowchart illustrating an example of processing carried out by an ITR according to the third embodiment. The process of FIG. 24 is described next according to the step numbers in the flowchart. The third embodiment differs in that the router 100 executes steps S13a to S15a, in place of steps S13 to S15 described in FIG. 15. The remaining steps S11, S12, and S16 to S19 are the same as those described in FIG. 15. Therefore, the following only describes steps S13a to S15a.

[Step S13a] Referring to the neighboring gateway management table 111a stored in the storing unit 110, the EID-to-RLOC processing unit 122 acquires IP addresses of the individual interfaces (interface addresses) connected to the neighboring gateways (the routers 200 and 200a). The EID-to-RLOC processing unit 122 generates the EID-to-RLOC requesting message 51a including a list of the interface addresses (ITR address list), which is then transmitted to the server 400.

[Step S14a] The EID-to-RLOC processing unit 122 receives, from the router 200, the EID-to-RLOC reply message 53b in response to the EID-to-RLOC requesting message 51a. In addition, the EID-to-RLOC processing unit 122 receives, from the router 200a, the EID-to-RLOC reply message 53c in response to the EID-to-RLOC requesting message 51a. The TTL value included in each of the EID-to-RLOC reply messages 53b and 53c has been changed by routers having relayed the EID-to-RLOC reply message 53b/53c.

[Step S15a] Based on the EID-to-RLOC reply message 53b and 53c, the EID-to-RLOC processing unit 122 selects, between the routers 200 and 200a, one having the maximum TTL value as the next-hop router. Note that the EID-to-RLOC reply message 53b is received from the port 105c. Therefore, the EID-to-RLOC processing unit 122 understands that the EID-to-RLOC reply message 53b has been received from the router 200. Note also that the EID-to-RLOC reply message 53c is received from the port 105d. Therefore, the EID-to-RLOC processing unit 122 understands that the EID-to-RLOC reply message 53c has been received from the router 200a. Assume, for example, that the TTL included in the EID-to-RLOC reply message 53b (at the time of arrival at the router 100) is “10” and the TTL included in the EID-to-RLOC reply message 53c (at the time of arrival at the router 100) is “5”. The TTL “10” is larger than the TTL “5”, and therefore the TTL set in the EID-to-RLOC reply message 53b is the maximum TTL. As a result, the EID-to-RLOC processing unit 122 selects the router 200 as the next-hop router. Subsequently, the process proceeds to step S16.

Thus, based on the EID-to-RLOC reply messages 53b and 53c transmitted from the router 300, the router 100 acquires information indicating distances between the individual routers 200 and 200a and the router 300.

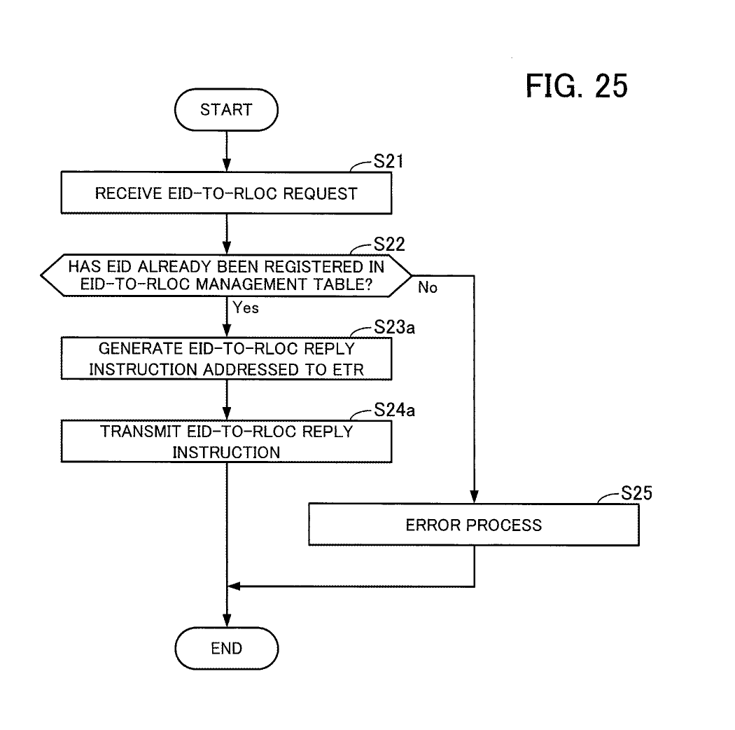

FIG. 25 is a flowchart illustrating an example of processing carried out by a server according to the third embodiment. The process of FIG. 25 is described next according to the step numbers in the flowchart. The third embodiment differs in that the server 400 executes steps S23a and S24a, in place of steps S23 and S24 described in FIG. 16. The remaining steps S21, S22, and S25 are the same as those described in FIG. 16. Therefore, the following describes only steps S23a and S24a. Note however that, in step S21, the managing unit 420 receives the EID-to-RLOC requesting message 51a, instead of the EID-to-RLOC requesting message 51.

[Step S23a] The managing unit 420 acquires the RLOC “RLOC2” corresponding to the EID “IP2” from the EID-to-RLOC management table 411. The managing unit 420 acquires IP addresses of the individual interfaces provided in the router 100 from the EID-to-RLOC requesting message 51a. Based on the acquired information, the managing unit 420 generates the EID-to-RLOC reply instruction message 52b. The EID-to-RLOC reply instruction message 52b includes the ITR address list “IF1, IF2” and the ETR address “RLOC2”. The EID-to-RLOC reply instruction message 52b is addressed to the router 300 functioning as the ETR.

[Step S24a] The managing unit 420 transmits the EID-to-RLOC reply instruction message 52b to the router 300.

As described above, the server 400 generates and transmits the EID-to-RLOC reply instruction message 52b addressed to the router 300 functioning as the ETR.

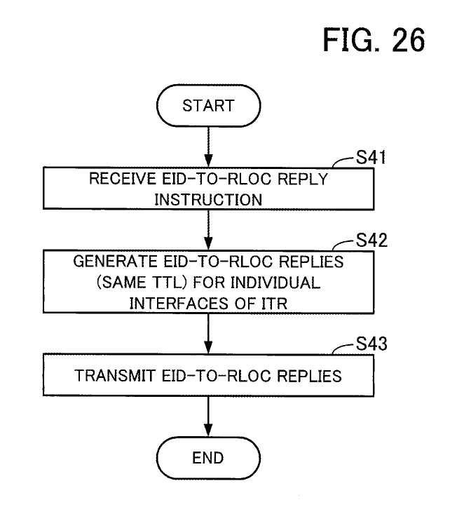

FIG. 26 is a flowchart illustrating an example of processing carried out by an ETR according to the third embodiment. The process of FIG. 26 is described next according to the step numbers in the flowchart.

[Step S41] The EID-to-RLOC processing unit 322 receives the EID-to-RLOC reply instruction message 52b from the server 400.

[Step S42] The EID-to-RLOC processing unit 322 acquires the interface addresses “IF1, IF2” from the EID-to-RLOC reply instruction message 52b. Then, the EID-to-RLOC processing unit 322 generates the EID-to-RLOC reply messages 53b and 53c. The EID-to-RLOC reply message 53b is addressed to an interface corresponding to the port 105c of the router 100. The EID-to-RLOC reply message 53c is addressed to an interface corresponding to the port 105d of the router 100. Each of the EID-to-RLOC reply messages 53b and 53c includes a predetermined TTL (for example, “20”) and the ETR address “RLOC2”.

[Step S43] The EID-to-RLOC processing unit 322 transmits the EID-to-RLOC reply messages 53b and 53c. The EID-to-RLOC reply message 53b goes through the router 200 to reach the router 100. The EID-to-RLOC reply message 53c goes through the router 200a to reach the router 100.

As described above, the router 300 generates the EID-to-RLOC reply messages 53b and 53c for the individual interfaces of the router 100 in response to the EID-to-RLOC reply instruction message 52b, and then transmits the generated EID-to-RLOC reply messages 53b and 53c. The router 200 simply transfers the EID-to-RLOC reply message 53b to the router 100 in its normal relay processing. Similarly, the router 200a simply transfers the EID-to-RLOC reply message 53c to the router 100 in its normal relay processing.

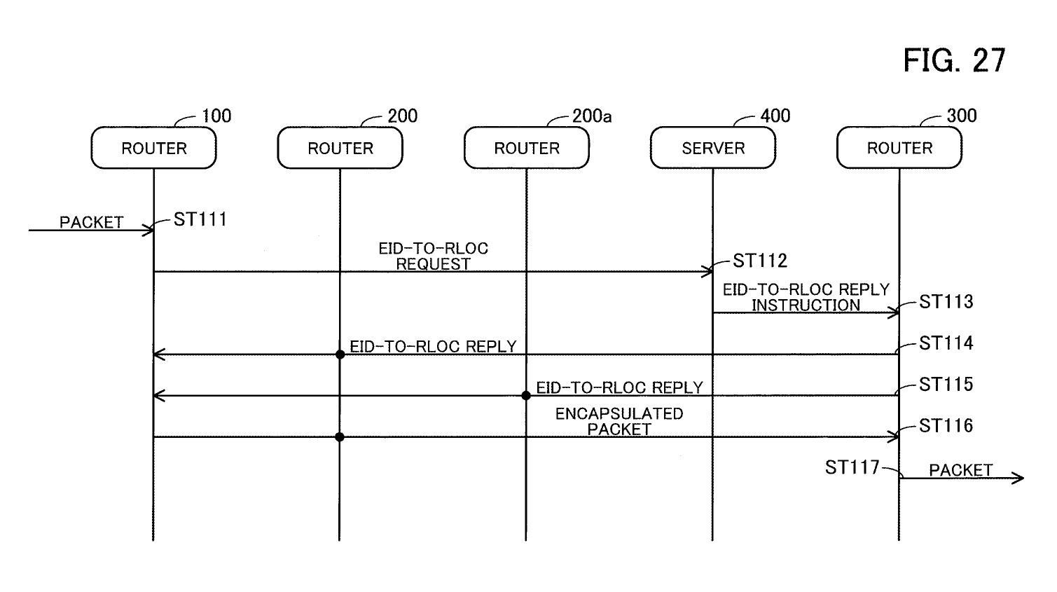

FIG. 27 is a sequence diagram illustrating a processing example according to the third embodiment. The process of FIG. 27 is described next according to the step numbers in the flowchart. The router 100 receives, from the client 500, the packet 50 addressed to the client 600 (step ST111). If the EID “IP2” of the client 600 is unregistered in the EID-to-RLOC cache table 113, the router 100 generates the EID-to-RLOC requesting message 51a. The router 100 transmits the EID-to-RLOC requesting message 51a to the server 400 (step ST112).

Upon receiving the EID-to-RLOC requesting message 51a, the server 400 refers to the EID-to-RLOC management table 411 to search for an entry of the EID “IP2” and then acquires the corresponding RLOC “RLOC2”. The server 400 generates the EID-to-RLOC reply instruction message 52b, which is then transmitted to the router 300 (step ST113).

The router 300 receives the EID-to-RLOC reply instruction message 52b. The router 300 acquires the interface addresses “IF1, IF2” from the EID-to-RLOC reply instruction message 52b and then generates the EID-to-RLOC reply messages 53b and 53c. The router 300 transmits the EID-to-RLOC reply message 53b. The value of the TTL included in the EID-to-RLOC reply message 53b is subtracted by 1 by each router intervening between the routers 300 and 200. The EID-to-RLOC reply message 53b goes through the router 200 to reach the router 100 (step S114). The router 300 transmits the EID-to-RLOC reply message 53c. The value of the TTL included in the EID-to-RLOC reply message 53c is subtracted by 1 by each router intervening between the routers 300 and 200a. The EID-to-RLOC reply message 53c goes through the router 200a to reach the router 100 (step S115). Steps ST114 and ST115 may be executed simultaneously, or their order of execution may be switched around.

Upon receiving the EID-to-RLOC reply messages 53b and 53c, the router 100 compares their TTLs. Assume that the value of the TTL included in the EID-to-RLOC reply message 53b is “10” while that included in the EID-to-RLOC reply message 53c is “5”. The router 100 selects the router 200 having the maximum TTL value as the next-hop router. Based on the selection result, the router 100 registers a new entry in each of the routing table 112 and the EID-to-RLOC cache table 113. The router 100 encapsulates the packet 50 to generate the encapsulated packet 60, which is then transmitted to the router 300. In this regard, the encapsulated packet 60 is transmitted from the port 105c. The encapsulated packet 60 goes through the router 200 to then reach the router 300 (step ST116). Upon receiving the encapsulated packet 60, the router 300 decapsulates the encapsulated packet 60 to obtain the packet 50. The router 300 transfers the packet 50 to the client 600 (step ST117).

In the above-described manner, the router 100 receives, from the router 200 and 200a, the EID-to-RLOC reply messages 53b and 53c, respectively, transmitted by the router 300. The EID-to-RLOC reply messages 53b and 53c include the TTLs. Based on the TTLs, the router 100 is able to evaluate the number of routers intervening between the router 300 and each of the routers 200 and 200a. That is, the router 100 acquires information indicating the distances from the individual routers 200 and 200a to the router 300 functioning as the ETR. Then, the router 100 selects the next-hop router based on the information.

For this reason, the router 100 need not participate in EGP (for example, BGP) of the core network 10, as in the second embodiment. Therefore, the router 100 does not have to collect core network routing information. As a result, the router 100 does not have to allocate a memory area of, for example, the RAM 102 for routing control, therefore saving the memory area. In addition, processing costs involved in evaluating route selection indexes by the router 100 are reduced. Further, as in the second embodiment, the third embodiment is able to reduce the level of processing performance called for the router 100 and therefore has a large cost advantage.

According to the third embodiment, when providing information indicating the individual distances to the router 100, the routers 200 and 200a do not have to evaluate the distances, thus reducing the workload of the routers 200 and 200a.

In addition, according to the third embodiment, the routers 200, 200a, and 200b simply carry out their normal packet transfer. Therefore, the third embodiment also has the advantage of being able to use existing routers for the routers 200, 200a, and 200b.

### (d) Fourth Embodiment

Next described is a fourth embodiment. The following focuses mainly on features different from those described in the previous second and third embodiments while omitting description of common features. According to the third embodiment, the router 100 transmits the single EID-to-RLOC requesting message 51a including the ITR address list to the server 400. In addition, the server 400 transmits the single EID-to-RLOC instruction message 52b including the ITR address list to the router 300. On the other hand, the router 100 may transmit, to the server 400, a plurality of EID-to-RLOC requesting messages for individual interface addresses. In addition, the server 400 may transmit, to the router 300, a plurality of EID-to-RLOC reply instruction messages for the individual interface addresses. Functions to implement this are described in the fourth embodiment.

Here, the information processing system of the fourth embodiment is the same as that of the third embodiment. Hardware and software examples of the fourth embodiment are the same as those of the third embodiment. Therefore, the same names and reference numerals as those in the third embodiment are given to the same devices in the fourth embodiment. Note however that the fourth embodiment differs from the third embodiment in EID-to-RLOC requesting messages and EID-to-RLOC reply instruction messages.

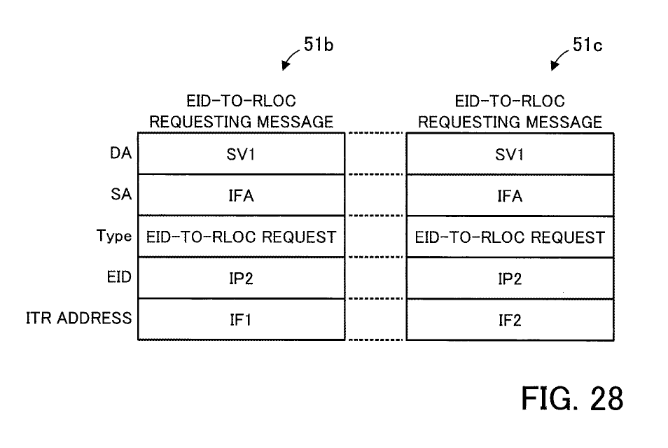

FIG. 28 illustrates an example of EID-to-RLOC requesting messages according to the fourth embodiment. The EID-to-RLOC processing unit 122 generates EID-to-RLOC requesting messages 51b and 51c in place of the EID-to-RLOC requesting message 51a of the third embodiment. Each of the EID-to-RLOC requesting messages 51b and 51c includes the following fields: destination address (DA); source address (SA); type; EID; and ITR address. Contents set in the destination address, source address, type, and EID fields are the same as those described in relation to the EID-to-RLOC requesting message 51. The ITR address field includes the IP address of one interface provided in the ITR, connected to a neighboring gateway. For example, when the router 100 has received, from the client 500, a packet with a destination address being the client 600, the EID-to-RLOC requesting messages 51b and 51c are configured as follows.

As for the EID-to-RLOC requesting message 51b, the destination address field contains “SV1” because the EID-to-RLOC requesting message 51b is addressed to the server 400. The source address field contains “IFA” because the transmission source is the port 105b. The type field contains “EID-to-RLOC request” because the EID-to-RLOC requesting message 51b is an EID-to-RLOC requesting message. The EID field contains “IP2” because the router 100 needs to transfer the packet addressed to the client 600. The ITR address field contains “IF1” because “IF1” is registered in the neighboring gateway management table 111a as an interface address corresponding to one of the neighboring gateways.

As for the EID-to-RLOC requesting message 51c, the ITR address field contains “IF2” because “IF2” is registered in the neighboring gateway management table 111a as an interface address corresponding to the other one of the neighboring gateways. Contents set in the remaining fields are the same as those of the EID-to-RLOC requesting message 51b.

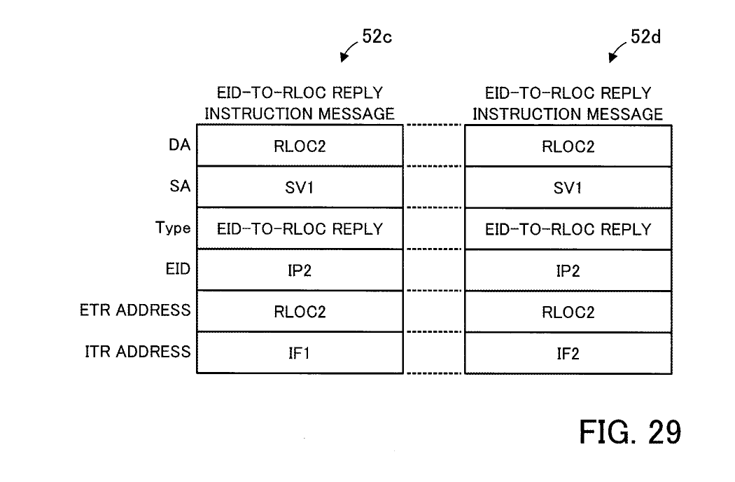

FIG. 29 illustrates an example of EID-to-RLOC reply instruction messages according to the fourth embodiment. The managing unit 420 generates EID-to-RLOC reply instruction messages 52c and 52d in place of the EID-to-RLOC reply instruction message 52b of the third embodiment. Each of the EID-to-RLOC reply instruction messages 52c and 52d includes the following fields: destination address (DA); source address (SA); type; EID; ETR address; and ITR address. Contents set in the destination address, source address, type, EID, and ETR address fields are the same as those described in relation to the EID-to-RLOC reply instruction messages 52 and 52a. A content set in the ITR address field is the same as that described in relation to the EID-to-RLOC requesting messages 51b and 51c. For example, the EID-to-RLOC reply instruction messages 52c and 52d to be transmitted by the server 400 in response to the EID-to-RLOC requesting messages 51b and 51c, respectively, are configured as follows.

As for the EID-to-RLOC reply instruction message 52c, the destination address field contains “RLOC2” because the EID-to-RLOC reply instruction message 52c is addressed to the router 300 functioning as the ETR. The source address field contains “SV1” because the transmission source is the server 400. The type field contains “EID-to-RLOC reply” because the EID-to-RLOC reply instruction message 52c is an EID-to-RLOC reply instruction message. The EID field contains “IP2” because the EID “IP2” has been designated in the EID-to-RLOC requesting message 51b. The ETR address field contains “RLOC2” because an RLOC corresponding to the EID “IP2” is “RLOC2”. The ITR address field contains the ITR address “IF1” because “IF1” has been designated in the EID-to-RLOC requesting message 51b.

As for the EID-to-RLOC reply instruction message 52d, the ITR address field contains “IF2” because the ITR address “IF2” has been designated in the EID-to-RLOC requesting message 51c. Contents set in the remaining fields are the same as those of the EID-to-RLOC reply message 52c.

Note that processing procedures of the fourth embodiment are the same as those of the third embodiment described in FIGS. 24 to 26, and repeated description is omitted here. Note however that, in step S13a, the EID-to-RLOC processing unit 122 transmits the EID-to-RLOC requesting messages 51b and 51c to the server 400 in place of the EID-to-RLOC requesting message 51a. In addition, in steps S23a and S24a, the managing unit 420 generates the EID-to-RLOC reply instruction messages 52c and 52d in place of the EID-to-RLOC replay instruction message 52b and then transmits the generated EID-to-RLOC reply instruction messages 52c and 52d to the router 300. The remaining steps are executed based on information set in the EID-to-RLOC requesting messages 51b and 51c and the EID-to-RLOC reply instruction messages 52c and 52d.

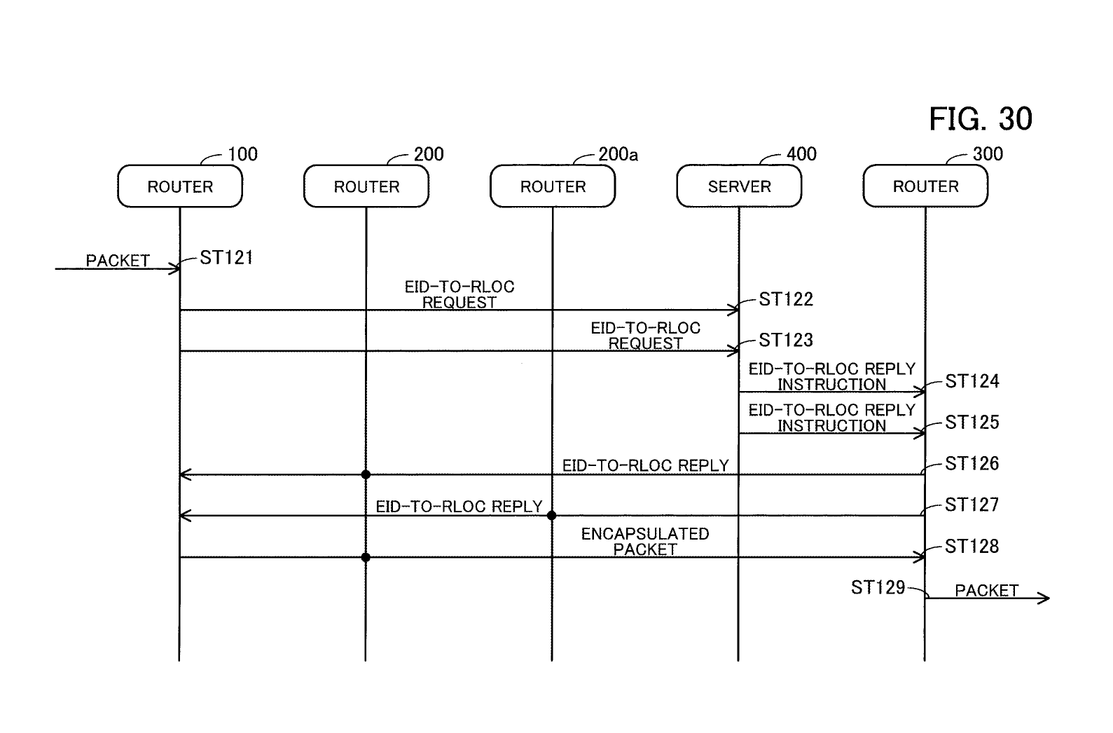

FIG. 30 is a sequence diagram illustrating a processing example according to the fourth embodiment. The process of FIG. 30 is described next according to the step numbers in the flowchart. The router 100 receives, from the client 500, the packet 50 addressed to the client 600 (step ST121). If the EID “IP2” of the client 600 is unregistered in the EID-to-RLOC cache table 113, the router 100 generates the EID-to-RLOC requesting messages 51b and 51c. The router 100 transmits the EID-to-RLOC requesting message 51b to the server 400 (step ST122). The router 100 also transmits the EID-to-RLOC requesting message 51c to the server 400 (step ST123). Steps ST122 and ST123 may be executed simultaneously, or their order of execution may be switched around.

Upon receiving the EID-to-RLOC requesting messages 51b and 51c, the server 400 refers to the EID-to-RLOC management table 411 to search for an entry of the EID “IP2” and then acquires the corresponding RLOC “RLOC2”. The server 400 generates the EID-to-RLOC reply instruction messages 52c and 52d. The server 400 transmits the EID-to-RLOC reply instruction message 52c to the router 300 (step ST124). The server 400 also transmits the EID-to-RLOC reply instruction message 52d to the router 300 (step ST125). Steps ST124 and ST125 may be executed simultaneously, or their order of execution may be switched around.

Upon receiving the EID-to-RLOC reply instruction message 52c, the router 300 acquires the interface address “IF1” from the EID-to-RLOC reply instruction message 52c and then generates the EID-to-RLOC reply message 53b. The router 300 transmits the EID-to-RLOC reply message 53b. The value of the TTL included in the EID-to-RLOC reply message 53b is subtracted by 1 by each router intervening between the routers 300 and 200. The EID-to-RLOC reply message 53b goes through the router 200 to reach the router 100 (step ST126).

Upon receiving the EID-to-RLOC reply instruction message 52d, the router 300 acquires the interface address “IF2” from the EID-to-RLOC reply instruction message 52d and then generates the EID-to-RLOC reply message 53c. The router 300 transmits the EID-to-RLOC reply message 53c. The value of the TTL included in the EID-to-RLOC reply message 53c is subtracted by 1 by each router intervening between the routers 300 and 200a. The EID-to-RLOC reply message 53c goes through the router 200a to reach the router 100 (step ST127). Steps ST126 and ST127 may be executed simultaneously, or their order of execution may be switched around.

Upon receiving the EID-to-RLOC reply messages 53b and 53c, the router 100 compares their TTLs. Assume that the value of the TTL included in the EID-to-RLOC reply message 53b is “10” while that included in the EID-to-RLOC reply message 53c is “5”. The router 100 selects the router 200 having the maximum TTL value as the next-hop router. Based on the selection result, the router 100 registers a new entry in each of the routing table 112 and the EID-to-RLOC cache table 113. The router 100 encapsulates the packet 50 to generate the encapsulated packet 60, which is then transmitted to the router 300. In this regard, the encapsulated packet 60 is transmitted from the port 105c. The encapsulated packet 60 goes through the router 200 to then reach the router 300 (step ST128). Upon receiving the encapsulated packet 60, the router 300 decapsulates the encapsulated packet 60 to obtain the packet 50. The router 300 transfers the packet 50 to the client 600 (step ST129).

In the above-described manner, the router 100 receives, from the router 200 and 200a, the EID-to-RLOC reply messages 53b and 53c, respectively, transmitted by the router 300. The EID-to-RLOC reply messages 53b and 53c include the TTLs. Based on the TTLs, the router 100 is able to evaluate the number of routers intervening between the router 300 and each of the routers 200 and 200a. That is, the router 100 acquires information indicating the distances from the individual routers 200 and 200a to the router 300 functioning as the ETR. Then, the router 100 selects the next-hop router based on the information.

In the above-described manner, the router 100 need not participate in EGP (for example, BGP) of the core network 10, as in the second embodiment. Therefore, the router 100 does not have to collect core network routing information. As a result, the router 100 does not have to allocate a memory area of, for example, the RAM 102 for routing control, therefore saving the memory area. In addition, processing costs involved in evaluating route selection indexes by the router 100 are reduced.

Further, as in the second embodiment, the third embodiment is able to reduce the level of processing performance called for the router 100 and therefore has a large cost advantage. In addition, according to the fourth embodiment, the routers 200, 200a, and 200b simply carry out their normal packet transfer, as in the third embodiment. Therefore, the fourth embodiment also has the advantage of being able to use existing routers for the routers 200, 200a, and 200b.

Further, the control of the fourth embodiment is achieved by using a message format defined by the LISP. Therefore, the fourth embodiment also has the advantage of needing relatively low modification work cost in implementation of the functions of the routers 100 and 300.

### (e) Fifth Embodiment

Next described is a fifth embodiment. The following focuses mainly on features different from those described in the previous second to fourth embodiments while omitting description of common features. According to the third embodiment, the router 100 transmits, to the server 400, the EID-to-RLOC requesting message 51a including the ITR address list. On the other hand, one IP address of the router 100 functioning as the ITR may be designated in an EID-to-RLOC requesting message. Functions to implement this are described in the fifth embodiment.

Here, the information processing system of the fifth embodiment is the same as that of the third embodiment. Hardware and software examples of the fifth embodiment are the same as those of the third embodiment. Therefore, the same names and reference numerals as those in the third embodiment are given to the same devices in the fifth embodiment. Note however that the fifth embodiment differs from the third embodiment in an EID-to-RLOC requesting message, an EID-to-RLOC reply instruction message, and an EID-to-RLOC reply message.

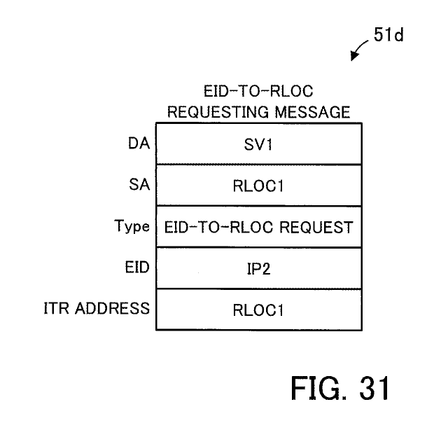

FIG. 31 illustrates an example of an EID-to-RLOC requesting message according to the fifth embodiment. The EID-to-RLOC processing unit 122 generates an EID-to-RLOC requesting message 51d in place of the EID-to-RLOC requesting message 51a of the third embodiment. The EID-to-RLOC requesting message 51d includes the following fields: destination address (DA); source address (SA); type; EID; and ITR address. Contents set in the destination address, source address, type, EID, and ITR address fields are the same as those described in relation to the EID-to-RLOC requesting message 51. For example, when the router 100 has received, from the client 500, a packet with a destination address being the client 600, the EID-to-RLOC requesting message 51d is configured as follows.

The destination address field contains “SV1” because the EID-to-RLOC requesting message 51d is addressed to the server 400. The source address field contains “RLOC1” because the transmission source is the router 100. The type field contains “EID-to-RLOC request” because the EID-to-RLOC requesting message 51d is an EID-to-RLOC requesting message. The EID field contains “IP2” because the router 100 needs to transfer the packet addressed to the client 600. The ITR address field contains “RLOC1” because the requestor is the router 100.

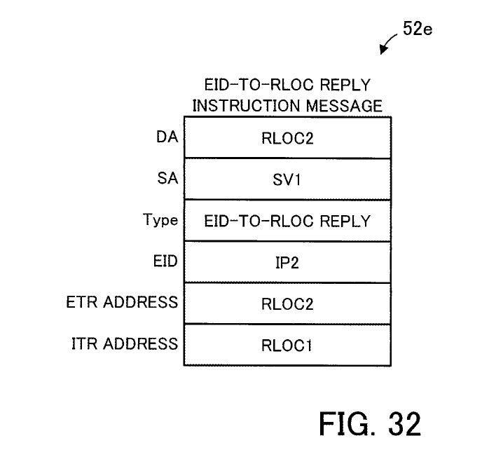

FIG. 32 illustrates an example of an EID-to-RLOC reply instruction message according to the fifth embodiment. The managing unit 420 generates an EID-to-RLOC reply instruction message 52e in place of the EID-to-RLOC reply instruction message 52b of the third embodiment. The EID-to-RLOC reply instruction message 52e includes the following fields: destination address (DA); source address (SA); type; EID; ETR address; and ITR address. Contents set in the destination address, source address, type, EID, ETR address, and ITR address fields are the same as those described in relation to the EID-to-RLOC reply instruction messages 52 and 52a. For example, the EID-to-RLOC reply instruction message 52e to be transmitted by the server 400 in response to the EID-to-RLOC requesting message 51d is configured as follows.

The destination address field contains “RLOC2” because the EID-to-RLOC reply instruction message 52e is addressed to the router 300 functioning as the ETR. The source address field contains “SV1” because the transmission source is the server 400. The type field contains “EID-to-RLOC reply” because the EID-to-RLOC reply instruction message 52e is an EID-to-RLOC reply instruction message. The EID field contains “IP2” because the EID “IP2” has been designated in the EID-to-RLOC requesting message 51d. The ETR address field contains “RLOC2” because a RLOC corresponding to the EID “IP2” is “RLOC2”. The ITR address field contains “RLOC1” because the requestor is the router 100.

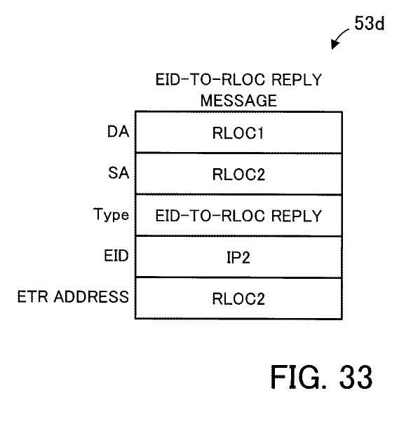

FIG. 33 illustrates an example of an EID-to-RLOC reply message according to the fifth embodiment. The managing unit 420 generates an EID-to-RLOC reply messages 53d in place of the EID-to-RLOC reply messaged 53b and 53c of the third embodiment. The EID-to-RLOC reply message 53d includes the following fields: destination address (DA); source address (SA); type; EID; and ETR address. Contents set in the destination address, source address, type, EID and ETR address fields are the same as those described in relation to the EID-to-RLOC reply messages 53 and 53a. The EID-to-RLOC reply message 53d transmitted by the router 300, for example, in response to the EID-to-RLOC reply instruction message 52e are configured as follows.

The destination address field contains “RLOC1” because the EID-to-RLOC reply message 53d is addressed to the router 100. The source address field contains “RLOC2” because the transmission source is the router 300. The type field contains “EID-to-RLOC replay” because the EID-to-RLOC reply message 53d is an EID-to-RLOC reply message. The EID field contains “IP2” because the EID “IP2” has been designated in the EID-to-RLOC reply instruction message 52e. The ETR address field contains “RLOC2” because the ETR address “RLOC2” has been designated in the EID-to-RLOC reply instruction message 52e. The EID-to-RLOC reply message 53d goes through either one of the routers 200 and 200a to reach the router 100.

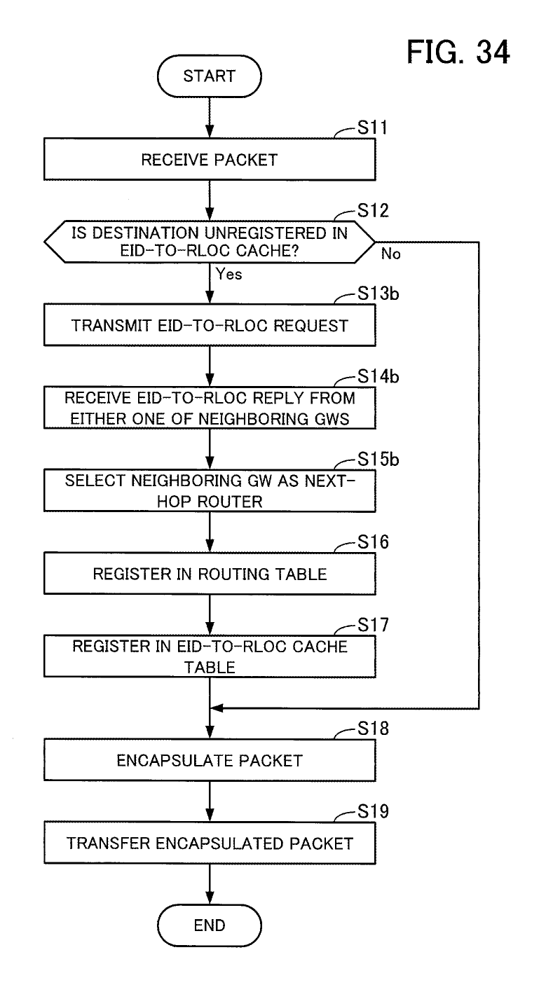

FIG. 34 is a flowchart illustrating an example of processing carried out by an ITR according to the fifth embodiment. The process of FIG. 34 is described next according to the step numbers in the flowchart. The fifth embodiment differs in that the router 100 executes steps S13b to S15b in place of steps S13a to S15a described in FIG. 24. The remaining steps S11, S12, and S16 to S19 are the same as those described in FIG. 15. Therefore, the following only describes steps S13b to S15b.

[Step S13b] The EID-to-RLOC processing unit 122 generates the EID-to-RLOC requesting message 51d, which is then transmitted to the server 400.

[Step S14b] In response to the EID-to-RLOC requesting message 51d, the EID-to-RLOC processing unit 122 receives the EID-to-RLOC reply message 53d from either one of the routers 200 and 200a.

[Step S15b] The EID-to-RLOC processing unit 122 selects, as the next-hop router, a router connected to a port having received the EID-to-RLOC reply message 53d. For example, when having received the EID-to-RLOC reply message 53d from the port 105c (i.e., when having received the EID-to-RLOC reply message 53d from the router 200), the EID-to-RLOC processing unit 122 selects the router 200 as the next-hop router. Subsequently, the process proceeds to step S16.

Thus, in response to the EID-to-RLOC requesting message 51d, the router 100 selects, as the next-hop router, a neighboring gateway connected to the port having received the EID-to-RLOC reply message 53d. In step S16, an entry is added to the routing table 112 in the following manner. Specifically, according to the neighboring gateway management table 111a (or the neighboring gateway management table 111), a neighboring gateway address corresponding to the port 105c is “GW1”. Therefore, an entry with the network address of the RLOC2, “N-RLOC2”, in association with the next-hop address “GW1” is added to the routing table 112.

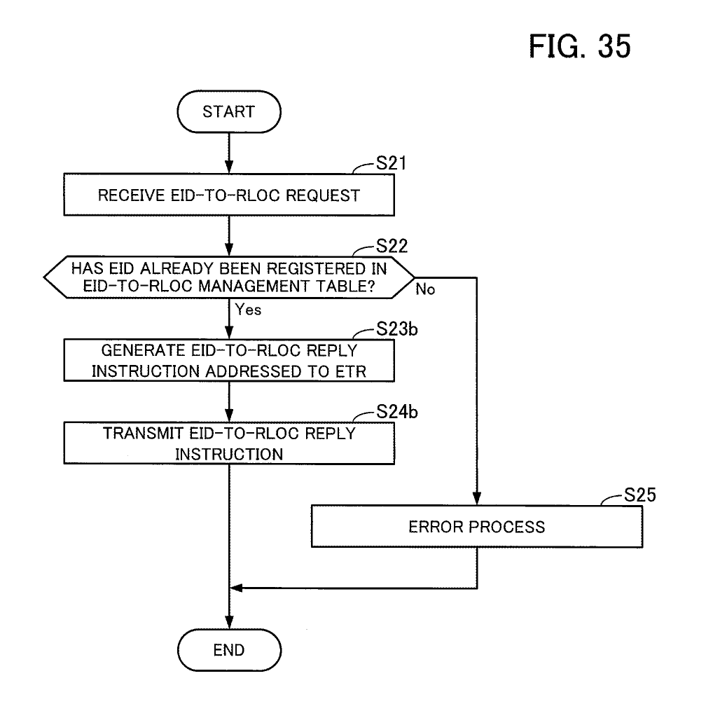

FIG. 35 is a flowchart illustrating an example of processing carried out by a server according to the fifth embodiment. The process of FIG. 35 is described next according to the step numbers in the flowchart. The fifth embodiment differs in that the server 400 executes steps S23b and S24b in place of steps S23a and S24a described in FIG. 25. The remaining steps S21, S22, and S25 are the same as those described in FIG. 16. Therefore, the following only describes steps S23b and S24b. Note however that, in step S21, the managing unit 420 receives the EID-to-RLOC requesting message 51d instead of the EID-to-RLOC requesting message 51a.

[Step S23b] The managing unit 420 acquires the RLOC “RLOC2” corresponding to the EID “IP2” from the EID-to-RLOC management table 411. The managing unit 420 acquires the ITR address “RLOC1” from the EID-to-RLOC requesting message 51d. Based on the acquired information, the managing unit 420 generates the EID-to-RLOC reply instruction message 52e. The EID-to-RLOC reply instruction message 52e includes the ITR address “RLOC1” and the ETR address “RLOC2”. The EID-to-RLOC reply instruction message 52e is addressed to the router 300.

[Step S24b] The managing unit 420 transmits the EID-to-RLOC reply instruction message 52e to the router 300.

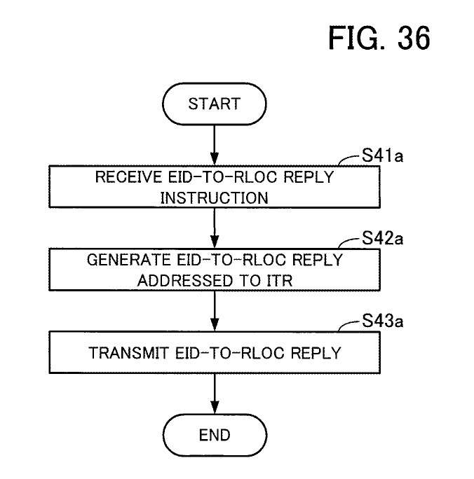

FIG. 36 is a flowchart illustrating an example of processing carried out by an ETR according to the fifth embodiment. The process of FIG. 36 is described next according to the step numbers in the flowchart.

[Step S41a] The EID-to-RLOC processing unit 322 receives the EID-to-RLOC reply instruction message 52e from the server 400.

[Step S42a] The EID-to-RLOC processing unit 322 acquires the ITR address “RLOC1” from the EID-to-RLOC reply instruction message 52e. The EID-to-RLOC processing unit 322 generates the EID-to-RLOC reply message 53d, which is addressed to the router 100.

[Step S43a] The EID-to-RLOC processing unit 322 transmits the EID-to-RLOC reply message 53d to the router 100. The EID-to-RLOC reply message 53d goes through either one of the routers 200 and 200a to reach the router 100.

As described above, in response to the EID-to-RLOC reply instruction message 52e, the router 300 generates the EID-to-RLOC reply message 53d, which is then transmitted to the router 100. The EID-to-RLOC reply message 53d reaches the router 100 after passing through one of packet transfer routes across the core network 10. In this regard, the EID-to-RLOC reply message 53d goes through either one of the routers 200 and 200a.

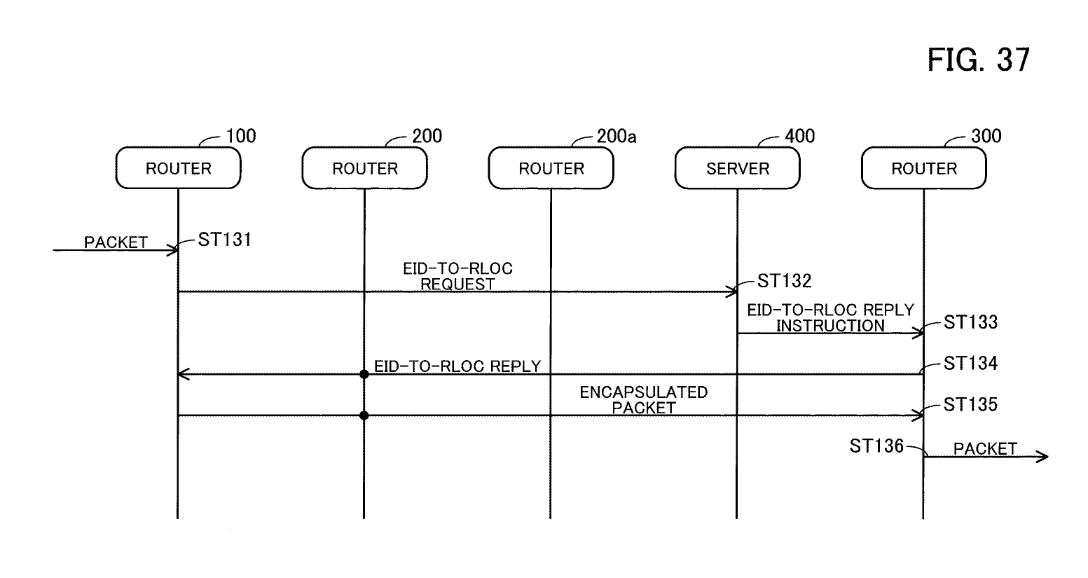

FIG. 37 is a sequence diagram illustrating a processing example according to the fifth embodiment. The process of FIG. 37 is described next according to the step numbers in the flowchart. The router 100 receives, from the client 500, the packet 50 addressed to the client 600 (step ST131). If the EID “IP2” of the client 600 is unregistered in the EID-to-RLOC cache table 113, the router 100 generates the EID-to-RLOC requesting message 51d. The router 100 transmits the EID-to-RLOC requesting message 51d to the server 400 (step ST132).

Upon receiving the EID-to-RLOC requesting message 51d, the server 400 refers to the EID-to-RLOC management table 411 to search for an entry with the EID “IP2” and then acquires the corresponding RLOC “RLOC2”. The server 400 generates the EID-to-RLOC reply instruction message 52e, and then transmits it to the router 300 (step ST133). The router 300 receives the EID-to-RLOC reply instruction message 52e. The router 300 acquires the ITR address “RLOC1” from the EID-to-RLOC reply instruction message 52e and then generates the EID-to-RLOC reply message 53d. The router 300 transmits the EID-to-RLOC reply message 53d, which then goes through the router 200 to reach the router 100 (step ST134).

Upon receiving the EID-to-RLOC reply message 53d, the router 100 selects the router 200 corresponding to the port 105c having received the EID-to-RLOC reply message 53d as the next-hop router. Based on the selection result, the router 100 registers a new entry in each of the routing table 112 and the EID-to-RLOC cache table 113. The router 100 encapsulates the packet 50 to generate the encapsulated packet 60, which is then transmitted to the router 300. In this regard, the encapsulated packet 60 is transmitted from the port 105c. The encapsulated packet 60 goes through the router 200 to then reach the router 300 (step ST135). Upon receiving the encapsulated packet 60, the router 300 decapsulates the encapsulated packet 60 to obtain the packet 50. The router 300 transfers the packet 50 to the client 600 (step ST136).

In the above-described manner, the router 100 receives the EID-to-RLOC reply message 53d from either one of the routers 200 and 200a in response to the EID-to-RLOC requesting message 51d. Subsequently, the router 100 selects the next-hop router according to the port having received the EID-to-RLOC reply message 53d.

For this reason, the router 100 need not participate in EGP (for example, BGP) of the core network 10, as in the second embodiment. Therefore, the router 100 does not have to collect core network routing information. As a result, the router 100 does not have to allocate a memory area of, for example, the RAM 102 for routing control, therefore saving the memory area. In addition, processing costs involved in evaluating route selection indexes by the router 100 are reduced. Further, as in the second embodiment, the fifth embodiment is able to reduce the level of processing performance called for the router 100 and therefore has a large cost advantage.

In addition, according to the fifth embodiment, the routers 200, 200a, and 200b simply carry out their normal packet transfer, as in the third embodiment. Therefore, the fifth embodiment also has the advantage of being able to use existing routers for the routers 200, 200a, and 200b.

Further, the control of the fifth embodiment is achieved by using an existing packet structure defined by the LISP. Therefore, the fifth embodiment also has the advantage of needing relatively low modification work cost in implementation of the functions of the routers 100 and 300.

In addition, according to the fifth embodiment, fewer packets are sent to the core network 10 for the ITR route selection compared to the second to fourth embodiments. Therefore, the fifth embodiment also has the advantage of reducing the load on the core network 10. This is true especially when the network addresses of individual interfaces corresponding to the ports 105c and 105d are the same. In this case, issuing only one EID-to-RLOC reply message is all that is needed since routing by each router is executed based on the network address. This is based on the idea that, even if a plurality of EID-to-RLOC reply messages are circulated, the plurality of EID-to-RLOC reply messages are received by either one of the ports 105c and 105d.

Further, the control of the fifth embodiment is achieved by using a message format defined by the LISP. Therefore, the fifth embodiment also has the advantage of needing relatively low modification work cost in implementation of the functions of the routers 100 and 300.

### (f) Sixth Embodiment

Next described is a sixth embodiment. The following focuses mainly on features different from those described in the previous second to fifth embodiments while omitting description of common features. According to the third embodiment, the router 300 is connected to the router 200b. On the other hand, the router 300 may be a multi-homing router. The sixth embodiment describes the control exercised when the router 300 is connected in a multi-homed architecture. Note here that the information processing system of the sixth embodiment differs in this regard (i.e., the router 300 is connected in a multi-homed architecture) from that of the third embodiment.

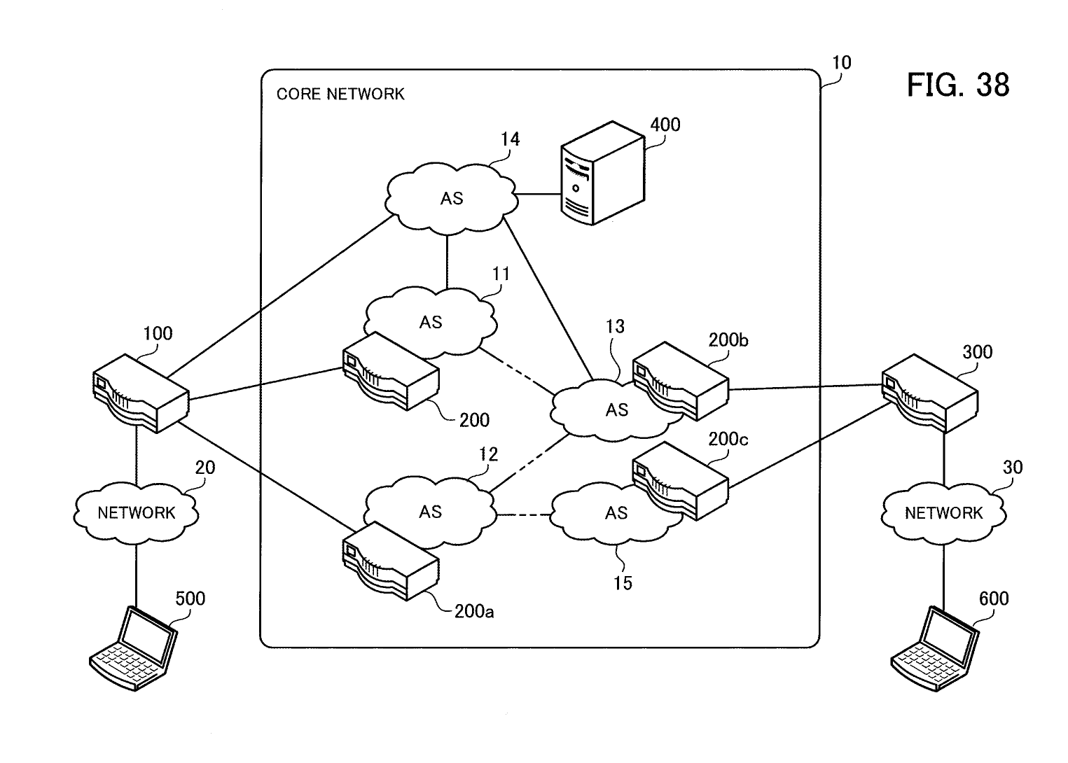

FIG. 38 illustrates an information processing system according to the sixth embodiment. The router 300 is connected not only to the router 200b but also to a router 200c. The router 200c is connected to an autonomous system 15 belonging to the core network 10. The autonomous system 15 is connected to the autonomous system 12. Between two autonomous systems, one or more different autonomous systems may intervene. Hardware and software examples of the sixth embodiment are the same as those of the third embodiment. Therefore, the same names and reference numerals as those in the third embodiment are given to the same devices in the sixth embodiment. In addition, the router 200c may be constructed with the same hardware configuration as the router 200. In this case, the router 300 may transmit an EID-to-RLOC reply message to each interface address of the router 100 and each neighboring gateway of the router 300 (i.e., each of the routers 200b and 200c). A specific example of this is described next.

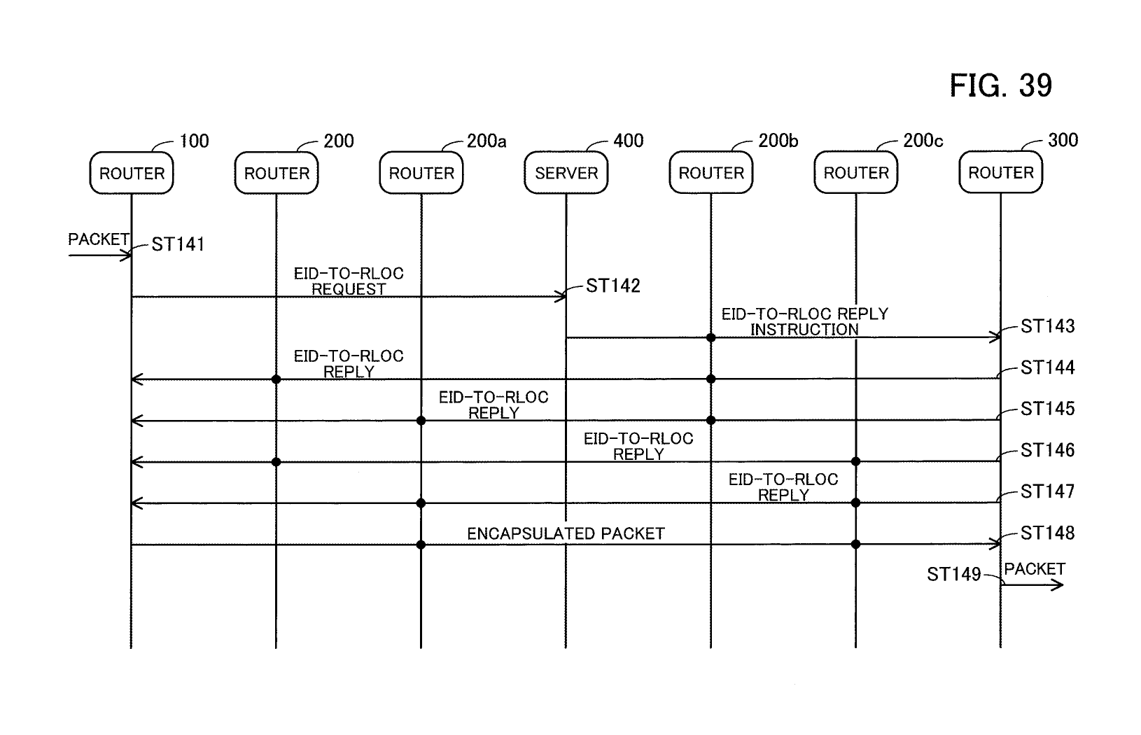

FIG. 39 is a sequence diagram illustrating a processing example according to the sixth embodiment. The process of FIG. 39 is described next according to the step numbers in the flowchart. The router 100 receives, from the client 500, the packet 50 addressed to the client 600 (step ST141). If the EID “IP2” of the client 600 is unregistered in the EID-to-RLOC cache table 113, the router 100 generates the EID-to-RLOC requesting message 51a, and then transmits it to the server 400 (step ST142).

Upon receiving the EID-to-RLOC requesting message 51a, the server 400 refers to the EID-to-RLOC management table 411 to search for an entry with the EID “IP2” and then acquires the corresponding RLOC “RLOC2”. The server 400 generates the EID-to-RLOC reply instruction message 52b. The server 400 transmits the EID-to-RLOC reply instruction message 52b to the router 300. The EID-to-RLOC reply instruction message 52b reaches the router 300, for example, via the router 200b (step ST143). Note however that a separate route may be provided between the router 300 and the server 400, like the route between the router 100 and the server 400.

The router 300 receives the EID-to-RLOC reply instruction message 52b. The router 300 acquires the interface addresses “IF1, IF2” from the EID-to-RLOC reply instruction message 52b. Then, the router 300 generates a total of four EID-to-RLOC reply messages each for the interface addresses “IF1, IF2” and the routers 200b and 200c. That is, the four EID-to-RLOC reply messages are two each of the EID-to-RLOC reply messages 53b and 53c described in FIG. 23 (all four have the same TTL value). The router 300 transmits the first EID-to-RLOC reply message 53b from a port to which the router 200b is connected. The first EID-to-RLOC reply message 53b goes through the routers 200b and 200 to then reach the router 100 (step ST144). The router 300 transmits the first EID-to-RLOC reply message 53c from a port to which the router 200b is connected. The first EID-to-RLOC reply message 53c goes through the routers 200b and 200a to then reach the router 100 (step ST145).

The router 300 transmits the second EID-to-RLOC reply message 53b from a port to which the router 200c is connected. The second EID-to-RLOC reply message 53b goes through the routers 200c and 200 to then reach the router 100 (step ST146). The router 300 transmits the second EID-to-RLOC reply message 53c from a port to which the router 200c is connected. The second EID-to-RLOC reply message 53c goes through the routers 200c and 200a to then reach the router 100 (step ST147). Steps ST144 to ST147 may be executed simultaneously, or in any different order.

Upon receiving the first and second EID-to-RLOC reply messages 53b and the first and second EID-to-RLOC reply messages 53c (a total of four EID-to-RLOC reply messages), the router 100 compares their TTL values. Assume here that the TTL value of the first EID-to-RLOC reply message 53b is “10”; that of the first EID-to-RLOC reply message 53c is “5”; that of the second EID-to-RLOC reply message 53b is “8”; and that of the second EID-to-RLOC reply message 53c is “12”. In this case, the router 100 selects the router 200a associated with the maximum TTL value as the next-hop router. Then, based on the selection result, the router 100 registers a new entry in each of the routing table 112 and the RLOC cache tale 113. The router 100 encapsulates the packet 50 to generate the encapsulated packet 60, which is then transmitted to the router 300. In this regard, the encapsulated packet 60 is transmitted from the port 105d. The encapsulated packet 60 goes through the routers 200a and 200c to then reach the router 300 (step ST148). Upon receiving the encapsulated packet 60, the router 300 decapsulates the encapsulated packet 60 to obtain the packet 50. The router 300 transfers the packet 50 to the client 600 (step ST149).

In this manner, the router 100 receives a total of four EID-to-RLOC reply messages from the individual routers 200 and 200a. Each of the EID-to-RLOC reply messages includes a TTL value. Based on the TTLs, the router 100 is able to evaluate the distances of the following Routes 1 to 4: Route 1 connecting between the routers 200 and 200b; Route 2 connecting between the routers 200a and 200b; Route 3 connecting the routers 200 and 200c; and Route 4 connecting the routers 200a and 200c. That is, the router 100 acquires information indicating the distance of each route, and selects the next-hop router based on the information.

For this reason, the router 100 need not participate in EGP (for example, BGP) of the core network 10, as in the second embodiment. Therefore, the router 100 does not have to collect core network routing information. As a result, the router 100 does not have to allocate a memory area of, for example, the RAM 102 for routing control, therefore saving the memory area. In addition, processing costs involved in evaluating route selection indexes by the router 100 are reduced. Further, as in the second embodiment, the sixth embodiment is able to reduce the level of processing performance called for the router 100 and therefore has a large cost advantage.

In addition, according to the sixth embodiment, the routers 200, 200a, 200b, and 200c simply carry out their normal packet transfer, as in the third embodiment. Therefore, the sixth embodiment also has the advantage of being able to use existing routers for the routers 200, 200a, 200b, and 200c.

In this regard, a method in which the server 400 collects core network routing information and provides the next-hop router for the router 100 functioning as the ITR may be considered appropriate. However, in this case, the server 400 needs to hold the core network routing information. On the other hand, according to the second to sixth embodiments, there is no need to cause another apparatus to hold the core network routing information. Therefore, the second to sixth embodiments have an advantage over this method.

The functions of the routers 100 and 300 described in each of the second to sixth embodiments above may be achieved by a computer equipped with a processor, RAM, and a plurality of communication interfaces. The above-described functions are achieved, for example, by the processor executing a program stored in the RAM. The program may be recorded on portable computer-readable storage media. To distribute the program, for example, storage media on which the program is recorded are provided. Alternatively, the program may be stored in a server computer and then transferred to the computer via a network. The computer stores, for example, in its own nonvolatile storage medium, the program originally recorded on a portable storage medium or acquired from the network, and then executes the program by loading it from the nonvolatile storage medium. Note however that the computer may directly execute the acquired program by sequentially loading the program into the RAM without storing it in the nonvolatile storage medium.

According to one aspect, it is possible to select a route without routing information.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a communication interface configured to receive, when a first relay apparatus connected to a first and a second network selects a transfer destination of data addressed to a third network connected to the second network, a query to resolve an address of a second relay apparatus on the second network from the first relay apparatus, the second relay apparatus being connected to the second and the third network; and
a processor configured to perform a procedure including:
causing, in response to the query, each of a plurality of third relay apparatuses belonging to the second network and being options of the transfer destination of the data to be transmitted from the first relay apparatus to provide, to the first relay apparatus, distance information indicating distance between the third relay apparatus and the second relay apparatus.

2. The information processing apparatus according to claim 1, wherein:
the causing includes causing each of the third relay apparatuses to provide, as the distance information, information indicating shortest distance between the third relay apparatus and the second relay apparatus.

3. The information processing apparatus according to claim 1, wherein:
the query includes individual addresses of the third relay apparatuses; and
the causing includes causing each of the third relay apparatuses to provide the distance information based on the individual addresses.

4. The information processing apparatus according to claim 1, wherein:
the causing includes causing each of the third relay apparatuses to provide, as the distance information, a time to live (TTL) or a hop limit included in each of a plurality of Internet protocol (IP) packets transmitted from the second relay apparatus and each reaching the first relay apparatus via a different one of the third relay apparatuses.

5. The information processing apparatus according to claim 4, wherein:
the query includes individual addresses of a plurality of interfaces provided in the first relay apparatus and each connected to a different one of the third relay apparatuses; and
the causing includes instructing the second relay apparatus to transmit the Internet protocol packets based on the individual addresses.

6. The information processing apparatus according to claim 1, wherein:
the causing includes causing each of the third relay apparatuses to provide, in addition to the distance information, the address of the second relay apparatus on the second network.

7. A relay apparatus used as one of a plurality of options of a transfer destination of data to be transmitted from a first relay apparatus connected to a first and a second network and addressed to a third network connected to the second network, the relay apparatus comprising:
a first communication interface configured to receive, when the first relay apparatus selects the transfer destination of the data, an instruction to provide, to the first relay apparatus, distance information indicating distance between the relay apparatus and a second relay apparatus connected to the second and the third network; and
a second communication interface configured to transmit the distance information to the first relay apparatus in response to the instruction.

8. The relay apparatus according to the claim 7, wherein:
the second communication interface transmits, as the distance information, information indicating shortest distance between the relay apparatus and the second relay apparatus.

9. The relay apparatus according to the claim 7, wherein:
the instruction includes an address of the second relay apparatus on the second network; and
the second communication interface transmits the distance information together with the address.

10. The relay apparatus according to the claim 7, wherein:
the second communication interface keeps routing information of the second network from being transmitted to the first relay apparatus.

11. A relay apparatus connected to a first and a second network, the relay apparatus comprising:
a first communication interface configured to receive, when a first relay apparatus connected to the second network and a third network selects a transfer destination of data addressed to the first network, an instruction to provide an address of the relay apparatus on the second network to the first relay apparatus; and
a second communication interface configured to transmit, in response to the instruction, each of a plurality of response data pieces to the first relay apparatus via a different one of a plurality of second relay apparatuses belonging to the second network and being options of the transfer destination of the data to be transmitted from the first relay apparatus, each of the response data pieces including the address and information to acquire distance information indicating distance between the relay apparatus and the first relay apparatus to receive the address.

12. The relay apparatus according to the claim 11, wherein:
the instruction includes individual addresses of a plurality of interfaces provided in the first relay apparatus and each connected to a different one of the second relay apparatuses; and
the second communication interface transmits the response data pieces based on the individual addresses.

13. The relay apparatus according to the claim 11, wherein:
the response data pieces are Internet protocol (IP) packets; and
the information to acquire the distance information is a time to live (TTL) or a hop limit included in each of the Internet protocol packets.

14. A relay apparatus comprising:
a communication interface configured to communicate with a plurality of first relay apparatuses belonging to a first network and being options of a transfer destination of data addressed to a second network connected to the first network; and
a processor configured to perform a procedure including:
making a query to resolve an address of a second relay apparatus on the first network, the second relay apparatus being connected to the first and the second network, and selecting, upon reception of a response to the query from one of the first relay apparatuses, the first relay apparatus as the transfer destination of the data.
